(19) United States
(12) Patent Application Publication
(10) Pub. No.: US 2026/0056540 A1
(43) Pub. Date: Feb. 26, 2026

(54) AQUATIC EQUIPMENT MONITORING SYSTEM AND METHOD

(71) Applicant: Pentair, Inc., Minneapolis, MN (US)

(72) Inventors: Patrick Theimer, Minneapolis, MN (US); Robert Prentice, Minneapolis, MN (US); Battista Remati, Minneapolis, MN (US); Brian Murphy, Minneapolis, MN (US); David Fiocco, Minneapolis, MN (US); Julie Gilbert, Minneapolis, MN (US); Uri Pelli, Minneapolis, MN (US); Robin Feng, Minneapolis, MN (US); Donnie Hampton, Minneapolis, MN (US); Sabrina Clark, Minneapolis, MN (US); Kolby Goodrich, Minneapolis, MN (US); Scott Woodruff, Minneapolis, MN (US)

(21) Appl. No.: 18/998,840

(22) PCT Filed: Jul. 26, 2023
(86) PCT No.: PCT/US2023/071060

§ 371 Date: Jan. 27, 2025

Related U.S. Application Data
(60) Provisional application No. 63/369,483, filed on Jul. 26, 2022.

(51) Int. Cl. G05B 23/02; E04H 4/14

(52) U.S. Cl. CPC G05B 23/0283; E04H 4/14

(57) ABSTRACT

A connected aquatic equipment monitoring system and method is provided. The system includes one or more system components, provided in the form of pool or spa equipment, that collect one or more data sets relating to a system component being monitored. A maintenance system with a programmable processor receives the one or more data sets, processes the one or more data sets to identify an operational parameter or status of the system component, and initiates a deployment system to generate customized recommendations for corrective action and/or generate one or more notifications to facilitate the servicing of the system component(s) by a third party.

### RELATED APPLICATIONS

This application claims priority to U.S. Provisional Patent Application No. 63/369,483 filed Jul. 26, 2022, the entire disclosure of which is incorporated herein by reference.

### BACKGROUND

Many aquatic equipment systems include serviceable system components or devices that involve repair, replacement, or other servicing. Existing systems are limited in their monitoring and analytic capabilities to provide predictive diagnostics and preventative maintenance recommendations. As such, there is a need for monitoring systems to gather analytics related to the health, status, and functionality of existing and/or newly added system components. In particular, there is an ongoing need to monitor aquatic equipment and the interconnected systems for one or more maintenance and/or service conditions.

Existing systems lack the processing systems, including data gathering and analytics techniques, to monitor and diagnose the health and status of a connected aquatic system and facilitate the efficient repair of the connected aquatic system. Furthermore, there is a need to provide an improved monitoring system that can interact with multiple system components and that is adapted, scaled, and can accommodate several different users, devices, manufacturers, and system configurations rather than only for a single device or type of device.

### SUMMARY

Embodiments described herein are generally directed to a connected aquatic equipment monitoring system that comprises one or more data capture devices that together collect data sets relating to one or more system components. More specifically, the data sets are communicated to a maintenance system via the connected system and the data sets can be stored in a remote server and communicated to third-party systems in communication with the connected system. The data set(s) can include one or more identifying details of the one or more system components and one or more operating parameters of the one or more system components.

In some embodiments, a method for monitoring one or more system components further comprises capturing a data set with one or more data capture devices integrated into a user device and/or connected to one or more system components of a connected system. The data sets can be stored in one or more databases of a maintenance system, wherein the maintenance system includes one or more advanced data processing modules. The maintenance system can utilize the one or more advanced data processing modules to identify operating parameters outside of a threshold value or threshold range. The method can further identify preventive maintenance options or actions and provide one or more customized recommendations for corrective action and/or addressing the identified issue(s).

In some embodiments, the system can recommend a third-party servicer to repair, replace, and/or service one or more system components. The system can further include a deployment module and a deployment process for developing and providing customized recommendations for third-party service providers for a particular service request based on one or more attributes using advanced analytic techniques. A notification module can be used to generate and transmit notifications associated with a service request to a user, a third-party servicer, a maintenance system expert, a mobile application, a third-party system, or any combination of these.

In some embodiments, the system can be used to perform remote operating procedures and/or to provide customized recommendations for user self-repair tasks. In one non-limiting example, the system can generate a customized library of tutorials and instructions based on a user's identified system component(s) and/or identified issue(s).

Some embodiments provide an aquatic equipment monitoring system designed to monitor a status of pool or spa equipment, including a first system component provided in the form of pool equipment and a first sensing device. The first sensing device collects a first data set including one or more operating parameters of the first system component. The system also includes a diagnostic module with a data processing module designed to receive and process the first data set collected from the first sensing device. The diagnostic module compares one or more values of the first data set to a predefined acceptable operational range. The system further includes a maintenance system with a programmable processor designed to execute instructions when the first system component is operating outside of the predefined acceptable operational range. The maintenance system generates a recommended corrective action.

In some embodiments, the aquatic equipment monitoring system further includes a second system component provided in the form of pool equipment and a second sensing device. The second sensing device collects a second data set including one or more operating parameters of the second system component. In some embodiments the first sensing device is a sensor integrated with the first system component and the second sensing device is a sensor integrated with the second system component. The system also includes a database designed to store the first data set and the second data set. In some forms, the system includes a central controller connected to a user device and a third-party interface via a network connection. The system can also include a deployment module designed to generate and send one or more notifications to the user device and the third-party interface based on the recommended corrective action from the maintenance system. In some embodiments, the first data set includes a unique identification code related to the first system component. In some forms, the unique identification code includes one or more of a product serial number, a manufacturer identifier, a barcode, a QR code, or a RFID tag. In some embodiments, the recommended corrective action includes one or more of: third-party service, a replacement system component, user self-repair, remote restart of the first system component, or an adjustment to the one or more operating parameters or settings of the first system component.

Some embodiments provide an aquatic equipment monitoring system designed to monitor a status of pool or spa equipment. The system can include a system component provided in a form of pool equipment and a sensing device that collects a data set including one or more operating parameters of the system component. The system can further include a central controller designed to receive and process the data set collected from the sensing device and compare one or more values of the data set to a predefined acceptable operational range. The system can also include a diagnostic module including the central controller, wherein the diagnostic module is designed to identify if the system component is operating outside of the predefined acceptable operational range. The system can also include a maintenance system designed to generate a recommended corrective action when the system component is operating outside of the predefined acceptable operational range. The system can also include a deployment module designed to generate a service request to a third-party service provider, wherein the service request includes one or more attributes related to the recommended corrective action.

In some embodiments, the system further includes a user device in communication with the central controller via a network, wherein the user device is designed to receive a user input and send the user input in the form of a user request to the central controller. In some forms, the system includes a notification module designed to generate and distribute one or more notifications to a user device via the central controller. In some forms, the one or more attributes of the service request includes a unique information code of the system component.

Some embodiments provide a method for monitoring a connected aquatic system. The method includes the step of receiving a data set from a sensing device, the data set relating to a system component provided in a form of pool equipment and the data set including a unique identification code and one or more operating parameters of the system component. The method can also include the step of extracting the unique identification code and one or more operating parameters of the system component. The method can also include initiating a diagnostic module to process the one or more operating parameters of the system component and comparing the one or more operating parameters of the system component to a predefined acceptable operational range. The method also includes determining if the one or more operating parameters are outside of the predefined acceptable operational range and initiating a maintenance system to develop a recommended corrective action for the system component and initiating a deployment module to take the recommended corrective action.

In some embodiments, the method also includes the steps of initiating a notification module to generate one or more notifications, transmitting a first notification of the one or more notifications to a third-party interface, and transmitting a second notification of the one or more notifications to a user device. In some forms, the recommended corrective action includes one or more of: requesting third-party service, ordering a replacement system component, instructing user self-repair, restarting the system component, or adjusting the one or more operating parameters or settings of the system component. In some forms, the method further includes determining when the recommended corrective action includes requesting third-party service. The method can also include generating a service request using the deployment module, wherein the service request includes one or more attributes related to the recommended corrective action. In some forms, the method also includes distributing the service request using a notification module to one or more third-party service providers based on a characteristic score. In some forms, the characteristic score can include one or more of a third-party service provider's: customer reviews, inventory, years in operation, number of locations, response time, availability of technicians, or weekend or evening service hours. The method can also include receiving a response from the one or more third-party service providers and scheduling a technician to complete the service request. In some forms, the method can further include extracting the unique identification code of the system component from the one or more attributes of the service request. In some embodiments, the unique identification code includes one or more of: a product serial number, a manufacturer identifier, a barcode, a QR code, or a RFID tag. The method can also include verifying the one or more third-party service providers has a characteristic matching the unique identification code of the system component, such that the one or more third-party service providers are capable of servicing the system component. The method can include distributing the service request using the notification module to the one or more third-party service providers with the characteristic matching the unique identification code of the system component. In some forms, the method further includes identifying a list of one or more preferred third-party service providers stored in a user record and distributing the service request using the notification module to the one or more third-party service providers on the list of preferred third-party service providers. In some embodiments, the method can also include comparing a usage data of the system component to a maintenance schedule using the diagnostic module, and generating a notification using a notification module, wherein the notification includes a maintenance reminder.

### DESCRIPTION OF THE DRAWINGS

FIG. 1 is a block diagram of a connected aquatic monitoring system according to disclosed embodiments;

FIG. 2 is a block diagram of a system component portion of the connected aquatic monitoring system of FIG. 1 according to disclosed embodiments;

FIG. 3 is a block diagram of system components of the connected aquatic monitoring system of FIG. 1 according to disclosed embodiments;

FIG. 4 is a block diagram of a maintenance system of the connected aquatic monitoring system of FIG. 1 according to disclosed embodiments;

FIG. 5 is a flow diagram of a data communication process according to disclosed embodiments;

FIG. 6 is a flow diagram of a data analytics process according to disclosed embodiments;

FIG. 7 is a flow diagram of a deployment process according to disclosed embodiments;

FIG. 8 is a flow diagram of a notification generation process according to disclosed embodiments;

FIG. 9 is a flow diagram of a data communication update process according to disclosed embodiments;

FIG. 10 is a flow diagram of a maintenance user notification generation process according to disclosed embodiments;

FIG. 11 is a flow diagram of an advanced data analytics taxonomy and process according to disclosed embodiments;

FIGS. 12A and 12B are illustrations of interface graphics of a user device according to disclosed embodiments;

FIGS. 13A-13C are illustrations of further interface graphics of a user device according to disclosed embodiments;

FIG. 14 is an illustration of a graphic interface generated by the maintenance system for third-party systems according to disclosed embodiments; and

FIG. 15 is an illustration of another graphic interface generated by the maintenance system for third-party systems according to disclosed embodiments.

### DETAILED DESCRIPTION

Before any embodiments of the system are explained in detail, it is to be understood that the system is not limited in its application to the details of construction and the arrangement of components set forth in the following description or illustrated in the following drawings. The system is capable of other embodiments and of being practiced or of being carried out in several ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the system. Several modifications to the illustrated embodiments will be readily apparent to those skilled in the art, and the generic principles herein can be applied to other embodiments and applications without departing from embodiments of the system. Thus, embodiments of the system are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the system. Skilled artisans will recognize the examples provided herein have many useful alternatives and fall within the scope of embodiments of the system.

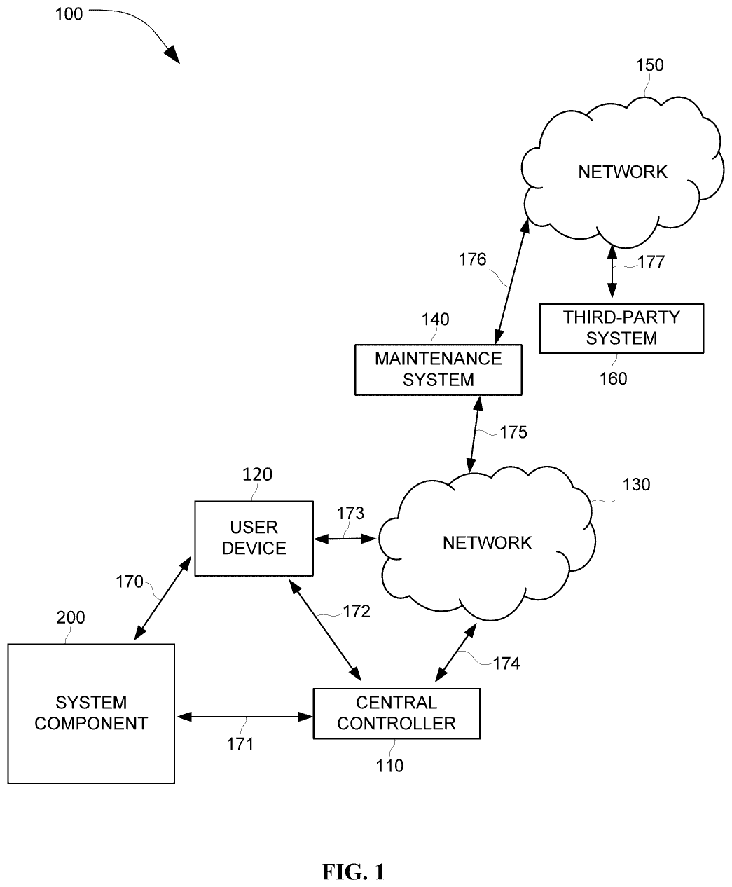

FIG. 1 illustrates an exemplary connected aquatic monitoring system 100 (hereinafter “connected system”), according to disclosed embodiments. When used throughout the disclosure, it will be understood by one skilled in the art that an “aquatic system” can include, for example, a pool or spa system, or similar. As seen in FIG. 1, the connected system 100 can include one or more user equipment system components 200 (hereinafter “system component(s)”), a central controller 110, a user device 120, a first network 130, a maintenance system 140, and a second network 150. The connected system 100 is designed to communicate with one or more third-party systems 160.

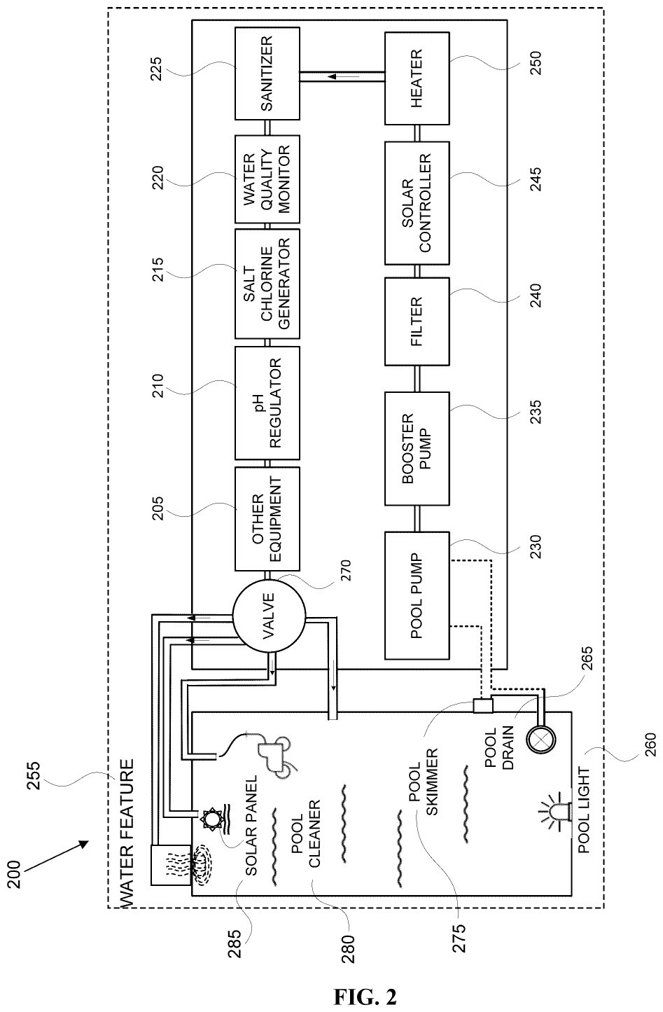

The one or more system components 200 can include any devices having a communication port, radio, or other communication module. Furthermore, as described in more detail in connection with FIG. 2, the one or more system components 200 can include, for example, one or more pool equipment devices, one or more sensors, one or more valves, one or more pumps having a variable frequency drive (VFD) and/or variable speed drive (VSD), one or more monitoring devices and/or detectors, several communication enabling devices, and/or other electrically controllable pool or spa related devices.

In some embodiments, the system components 200 can be connected to the first network 130, and controlled by the central controller 110, the one or more user device 120, and/or the maintenance system 140. The connected system 100 provides monitoring and control of the one or more system components 200 and communicates data to the maintenance system 140 for efficient identification of maintenance, service, or other issues, and deployment of service requests. In at least this way, the connected system 100 can provide advanced analytics for identifying a health value or status of one or more components of the connected aquatic system 100 and facilitate the efficient deployment of service requests, data, or other information to address identified issues or implement corrective action. Furthermore, the connected system 100 and/or maintenance system 140 can communicate with several system components 200, creating a monitoring system that is adaptable, scalable, and can accommodate multiple users, devices, manufacturers, and/or system configurations.

The one or more system components 200 can communicate with other aspects of the connected system 100 in order to send and receive one or more data sets, and can also provide dynamic monitoring and control of several aspects of the connected system 100. When used throughout the present disclosure, it will be recognized by one skilled in the art that “data sets” can include, but is not limited to, one or more data elements, single variable data sets, multiple variable data sets, data points, measurements, parameters, features, commands, notifications, metrics, readings, similar data component, or any combination of these, or other information or data.

In some embodiments, the one or more system components 200 can interface with the user device 120 either directly over a wired or wireless connection 170, or a connection 171 via the central controller 110. The user device 120 can interface with the central controller 110 either directly over a connection 172, or via a connection 173 to the first network 130. Similarly, the central controller 110 can interface with the maintenance system 140 via a connection 174 to the first network 130 and/or a connection 175 between the first network 130 and the maintenance system 140. It will be appreciated that other connection configurations are contemplated within the scope of the present disclosure.

The maintenance system 140 can be connected to the second network 150 via a connection 176 so as to control the one or more system components 200 and/or to receive and transmit data, as described in more detail below. The second network 150 (and the maintenance system 140) can interface with the third-party system 160 via a connection 177. Although FIG. 1 depicts the central controller 110 in communication with the user device 120, the first network 130, the maintenance system 140, and the second network 150, it should be noted that several communication processes and connections may be implemented to work in conjunction with, or independent from, one or more local controllers associated with each of the one or more system components 200 associated with the connected aquatic system 100 (e.g., controller of the pump, controller of the heater, etc.).

The components of the connected system 100 can be configured to communicate directly with one another using a network interface, local network, or other communication connection, and are not limited to the communication connections (e.g., 170-177) shown in FIG. 1. One skilled in the art will recognize that a communication connection, for example, but not limited to the communication connections 170-177, can transmit and receive data using one or more communication protocols, including but not limited to: wired, wireless, Bluetooth, cellular, satellite, GPS, RS-485, RF, MODBUS, CAN, CANBUS, DeviceNet, ControlNet, Ethernet TCP/IP, RS-232, Universal Serial Bus (USB), Firewire, Thread, proprietary protocol(s), or other known communication protocol(s) as applicable.

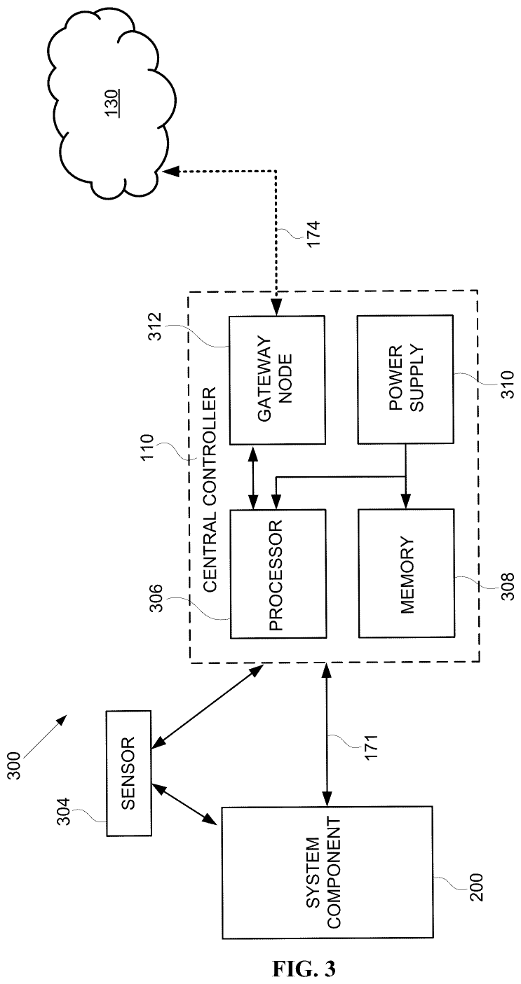

In some embodiments, the central controller 110 can be provided in the form of a data-processing device located proximate to the connected system 100. The central controller 110 is configured to transmit and receive data sets from the one or more system components 200 and/or the user device 120 to and from the maintenance system 140. For example, in some embodiments, the central controller 110 can be provided in the form of a network interface to create a communication link that operatively connects the one or more system components 200 and the user device 120 over the first network 130 to the maintenance system 140 and the remote second network 150. As described in more detail in connection with FIG. 3, in some embodiments, the central controller 110 is provided in the form of a gateway, hub, switch, router, server, switch, or other connection device to allow integration, monitoring, and control of several aspects of the connected system 100.

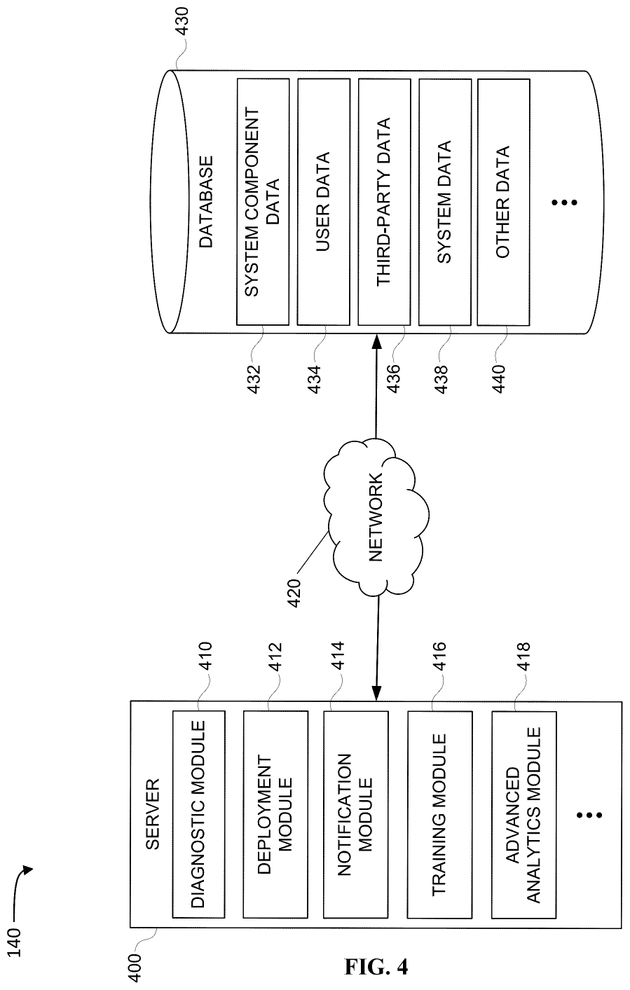

In one embodiment, the central controller 110 can receive one or more data sets from the one or more system components 200, process the one or more data sets, and report the processed data to the maintenance system 140. The central controller 110 can process the data according to one or more characteristics associated with a data set. For example, a system component 200 can transmit one or more data sets to the central controller 110. The central controller 110 can receive the one or more data sets and process the data set(s) according to one or more characteristics, including but not limited to: sensor data, a time stamp for the sensor data, a unique identification code for the system component 200, user data associated with the system component (e.g., install date, geographic location), usage data, error code, etc. The processed data can be transmitted from the central controller 110 to the maintenance system 140. In some embodiments, as described in connection with FIG. 4, the one or more data sets may be processed by the maintenance system 140.

When used throughout the disclosure, it will be understood by one skilled in the art that “data processing” techniques can include, for example, filtering, extracting, transforming, concatenating, aggregating, or other types of data manipulation, or a combination thereof.

A user can access one or more data sets and/or processed data from the connected system 100, stored in one or more databases 430 (see FIG. 4) of the maintenance system 140 (or stored in other locations). In one embodiment, the user may request one or more customized reports and the connected system 100 generates the one or more customized reports with processed data and/or data sets. As a non-limiting example, the user may request a usage report containing runtime and power consumption for a specific system component 200 associated with the user's connected system 100. In another example, the user may request a maintenance report including recommended maintenance procedures, timelines, and parts to fulfill a manufacturer's recommended maintenance procedures for one or more system components 200 of the user's connected system 100. The data sets from the connected system 100, including but not limited to sensor data described in connected with FIG. 2, can also be accessed using the user device 120 or the third-party system 160.

The user device 120 can be any device capable of connecting to the Internet. In one embodiment, the user device 120 is provided in the form of a portable device like a smartphone, tablet, laptop, other computing device, or other display interface. In some embodiments, the user device 120 can include, or is otherwise connected to, a programmable processor, a network interface, one or more data capture devices, and a memory unit. In some embodiments, the data capture devices can be provided in the form of one or more of a microphone, a camera, a vibration sensor, an accelerometer, and/or other sensing or recording device. In some embodiments, the user device 120 can include a Wi-Fi, Bluetooth, cellular, wired connection, wireless connection, or similar communication link used to communicate with a first network 130 and/or a second network 150. Furthermore, in some embodiments, the user device 120 can include program instructions that are stored on a user device 120 non-transitory computer readable medium and executed by the programmable processor to perform one or more of the processes described herein.

In one embodiment, a user can install an application on the user device 120 or display interface to access processed data and/or data sets associated with a user record. A user can set up or configure a user record when the user registers or installs one or more of the one or more system components 200. In some embodiments, the user may have several system components 200 associated with a given user record (e.g., some, most, or all of the aquatic equipment installed on a user's pool pad and/or in the pool or spa system). The user can further configure other aspects of the connected system 100 to be associated with the given user record in order to send and receive data associated with the user's specific system components 200 (e.g., a user's home automation system). A user record can contain personal information including user data 434 communicated to the maintenance system 140 as one or more data sets, as described in more detail in connection with FIG. 4. It will be understood by one skilled in the art that user “record” can also mean an account, profile, or similar.

A user can register a system component 200 to be associated with the user record using a configuration processes. In one non-limiting example, the user (e.g., homeowner, pool or spa owner, manufacturer, dealer, installer, and the like) can enter information about the system component 200 at the time of install, or anytime thereafter, such as the manufacturer or other system component data 432 (see FIG. 4). In some examples, the user could scan a receipt, barcode, QR code, or other identifier on or associated with the system component 200 or the packaging to register a system component 200 with a specific user record. In one embodiment, the system component data 432 can be communicated to the maintenance system 140 as a data set, as described in more detail in connection with FIG. 4. The connected system 100 can also be used to automatically identify and configure new system components 200 introduced to the connected system and associate the components with the user record. The connected system 100 can further be used to determine and establish the operating parameters and other baseline settings of the one or more system components 200 when a new device is introduced to the connected system 100. When used throughout the disclosure, it will be understood by one skilled in the art that “configuration” processes can include, for example, detection, identification, calibration, set-up, balance, tune, adjust, align, troubleshoot, or other types of establishing a device or device connection, or a combination thereof.

The maintenance system 140 and authorized third-party systems 160 can use the information provided during the configuration process and/or when registering the one or more system components 200 to a user record, as inputs to one or more analytics processes. The maintenance system 140 and user support personnel can access the provided information to support faster and more accurate diagnosis of a given problem, to determine recommended corrective action, to order replacement parts, to generate customized reports, and other tasks.

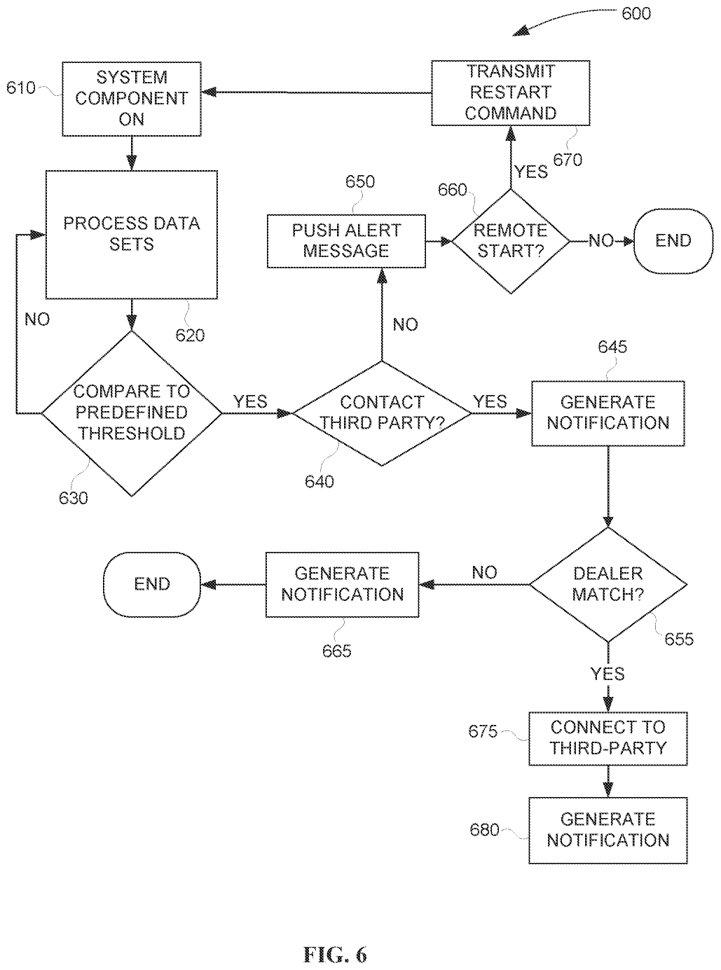

The user device 120 can be connected to the one or more system components 200 and/or the central controller 110. The user device 120 can be configured to receive alerts or notification related to the operation, functionality, and maintenance of the one or more system components 200. The user device 120 can also be used to send supplemental information to the maintenance system 140 via the first network 130 to assist in diagnostics, in one example. This process is described in more detail in connection with FIG. 6.

In some embodiments, the first network 130 is located proximate to the one or more system components 200. The first network 130 includes, for example, the Internet, intranets, extranets, wide area networks (“WANs”), local area networks (“LANs”), wired networks, wireless networks, cloud networks, or other suitable networks, or any combination of such networks. For example, such networks can include satellite networks, cable networks, Ethernet networks, and other types of networks. In one embodiment, the first network 130 is provided in the form of an isolated private network utilizing a private IP address and limiting access to the first network 130. In some embodiments, the first network 130 may include one or more computing devices that may be arranged, for example, in one or more server banks, computer banks, or other arrangements. Information related to the first network 130, including connectivity status, speed, security, connected devices, wireless interface, etc. can be communicated to the maintenance system 140 as a data set, as described in more detail in connection with FIG. 4.

The maintenance system 140 includes one or more data processing devices for sending, receiving, transforming, and otherwise processing data sets communicated by the connected system 100. The maintenance system 140 can store information and/or can access information via the first network 130 (e.g., stored in one or more remote databases or server systems), including data sets communicated from the one or more system components 200, the user device 120, and/or the central controller 110. The maintenance system 140 can further access information received or retrieved from external sources via the second network 150, including one or more data sets communicated from third-party systems 160. The maintenance system 140 can compare the data sets and determine if a particular system component 200 is operating outside of a threshold such that service or other corrective action is recommended. The maintenance system 140 can determine what type of service or corrective action is recommended using one or more diagnostic analysis processes, described in more detail below. Based on the determination of service and/or corrective action, the maintenance system 140 can generate and send one or more alerts to the third-party system(s) 160 and/or to the user device 120. In some embodiments one or more of the one or more system components 200 can send and receive data sets directly to and from the maintenance system 140. In some embodiments, the one or more system components 200 and/or the maintenance system 140 and/or the third-party system 160 can be in separate geographic locations (e.g., at a distance of more than 1 mile apart from each other, or 3 miles apart, or more than 5 miles apart).

In some embodiments, the second network 150, similar to the first network 130, can include, for example, the Internet, intranets, extranets, wide area networks (“WANs”), local area networks (“LANs”), wired networks, wireless networks, cloud networks, or other suitable networks, or any combination of such networks. For example, such networks can include satellite networks, cable networks, Ethernet networks, and other types of networks. The second network 150 can also be provided in the form of an isolated private network utilizing a private IP address and limiting access to the second network 150.

FIG. 2 illustrates an example of the one or more system components 200 that comprise an example aspect of a connected aquatic monitoring system 100 according to disclosed embodiments. The one or more system components 200 are provided in communication with each other and the pool or spa to form a fluid circuit. The fluid circuit facilitates water movement from the pool or spa through one or more of the one or more system components 200 and the fluid circuit to accomplish several tasks including, for example, pumping, cleaning, heating, sanitizing, lighting, and similar. Additional arrangements of the connected system 100 besides those shown in FIGS. 1 and 2 are also contemplated.

As illustrated in FIG. 2, the one or more system components 200 can include one or more of the following devices for operating and maintaining a residential aquatic system like a pool or spa: a pool pump 230, a booster pump 235, a filter 240, a solar controller 245, one or more solar panels 285, a heater 250, a sanitizer 225, a water quality monitor 220, a salt chlorine generator 215, a pH regulator 210, a water feature 255, a pool cleaner 280, a pool skimmer 275, a pool drain 265, a pool light 260, and other equipment 205. The one or more system components 200 can further include one or more valves 270 to control the individual system components 200. The one or more valves 270 can be controlled manually or remotely via the user device 120, the central controller 110, the maintenance system 140, one or more system components 200, or any combination thereof. The one or more valves 270 may be disposed at various locations throughout the pool plumbing to control the flow of fluid through the fluid circuit formed by the system components 200 of the connected aquatic monitoring system 100.

Each of the one or more system components 200 can include a unique identification code. The unique identification code may be assigned by the manufacturer, include a product serial number, be assigned when a user registers the component, or otherwise be associated with a user record after installation. In some examples, the user could scan a receipt, barcode, QR code, RFID tag, serial number, or another identification code on the system component(s) 200 or the packaging to register the one or more system components 200 with a user account. In one embodiment, the identification code associated system component data 432 can be extracted and stored in the database 430, lookup table, or similar.

Each of the one or more system components 200 can include one or more sensors provided in the form of an integrated sensor, an external sensor 304 coupled to or in communication with the component (as shown in FIG. 3), or both. It will be understood by those having skill in the art that the term “sensor” as used throughout the specification can include several variations of sensing devices, sensing device configurations, or other monitoring devices. In some embodiments, a sensor can be provided in the form of a sensor unit with one or more individual sensors, a single sensor with multiple sensing capabilities, or a combination of these.

In several embodiments, a sensor 304 integrated with or removably attached to one or more of the one or more system components 200 is designed to monitor the health, status, operating parameters, and diagnostic values of the system components 200. The sensor 304 can include different types of sensing components with one or more of the same type of sensing component. The sensor 304 can collect a one or more data sets from the system component 200 by placing the sensor 304 in more than one location based on a diagnostics aspect of the system component 200. Multiple sensors 304 can be installed based on the size, specifications, and complexity of the connected system 100. The sensor 304 can comprise one or more of a power sensor, temperature sensor, pressure sensor, gyro, accelerometer, vibration sensor, flow sensor, current sensor, voltage sensor, power sensor, frequency sensor, energy sensor, fault sensor, audio sensor, optic sensor, or any combination thereof. Moreover, the sensor 304 can be configured to collect one or more data sets from the one or more system components 200, or in some examples, the sensor 304 may collect data from several of the system components 200. In this non-limiting example, the sensor 304 can be provided in the form of a device with several sensing components to collect operating parameters and send one or more data sets including the operating parameters to the central controller 110 and/or the maintenance system 140. The central controller 110 and/or the maintenance system 140 can process the data sets provided by the sensor 304, according to the processes described below. The system 100 can also generate and send one or more alerts or notifications to the user device 120 and/or the third-party systems 160. In some embodiments, the sensor 304 can be located or disposed at a different geographic location than the maintenance system 140 and/or the third-party system 160 (e.g., at a distance greater than 1 mile, or greater than 3 miles, greater than 5 miles, or greater than 50 miles).

Each of the one or more system components 200 can collect, send, and receive one or more data sets to and from the maintenance system 140, via the central controller 110, and/or the user device 120. The one or more data sets collected and sent from the one or more system components 200 can include a data set with the specific component information from the manufacturer for the system component 200. As described above, this can include information entered either directly or indirectly from the user and can also include information retrieved by the maintenance system 140 and associated with the specific component, such as routine maintenance schedules and/or and system updates available from the manufacturer. The one or more data sets collected and sent via the one or more system components 200 can further include operating data collected from the sensor 304, or several sensors, associated with and connected to each of the one or more system components 200.

Each of the one or more system components 200 shown in FIG. 2 can include one or more of a sensor 304 (integrated and/or external) configured to collect one or more data sets associated with, the operating information and/or operating parameters for the system component 200. Non-limiting examples of the one or more system components 200 and the associated data collected from the one or more sensors 304 are described herein, but additional system components 200 and operating parameters will be recognized by those skilled in the art.

As a non-limiting example, the pool pump 230 and/or booster pump 235 may include one or more sensors 304 that can be designed to detect: power, vibration, current, flow, pressure, temperature, frequency, or a combination thereof. The power sensor can measure whether or not the pool pump 230 and/or booster pump 235 is connected to power, and/or whether it is activated. Additionally, some pool pumps and booster pumps have a soft start mode or similar controlled or reduced power mode, which can be measured and detected by the power sensor. The vibration sensor can measure vibration levels to identify electromagnetic or mechanical imbalance, loose components, rubbing parts, part failure, cavitation, or resonance. Some embodiments may further include an accelerometer to detect if the pump becomes unlevel. The current sensor can measure current flowing through the system using a non-intrusive method. The flow sensor can measure a flow of water that is pumped by a motor of the pool pump 230 and/or booster pump 235 and determines the actual health of the motor by determining if the flow rate is unexpectedly high or low based on the particular application and several threshold metrics. The flow sensor can also include a flow switch and/or a fluid velocity sensor to detect abnormal flow rate. The pressure sensor may monitor pressure in air compressors, irrigation systems, and heat exchangers that all use pumps to push air or water through their respective systems. The pressure sensor may further measure an input and differential pressure at the head of the pool pump 230 and/or booster pump 235. The one or more sensors 304 helps to overcome the faults and monitors the pool pump 230 and/or booster pump 235. Further, the temperature sensor monitors the temperature and helps to detect any abnormal temperature rise due to any malfunction or failure, which can include but is not limited to temperature measurements at the inlet, outlet, and motor. The frequency sensor can measure the frequency of the pool pump 230 and/or the booster pump 235 and can be used for controlling VFD's that may be associated with or connected to either the pool pump 230 and/or booster pump 235. In some embodiments an encoder may be used to measure and/or monitor the velocity of a rotor/impeller of the pool pump 230 and/or booster pump 235. Other sensors such as the voltage sensor can also monitor the input voltage and calculate the power factor of a motor of the pool pump 230 and/or the booster pump 235 using both current and voltage values of the connected system 100 and/or the values detected by the one or more sensors 304 connected to each of the pool pump 230 and/or the booster pump 235.

In another non-limiting example, the filter 240 may include one or more sensors 304 that can be designed to detect: pressure, flow, fluid velocity, or a combination thereof. The pressure sensor can detect and monitor differential pressure to identify when the filter may be dirty or clogged with debris. Routine maintenance alerts can be provided to regularly clean the filter 240 and extend the life of the filter 240. The flow sensor may include a flow switch and/or a fluid velocity sensor to measure the flow status and flow rate at the inlet, outlet, and backwash ports of the filter 240. Additionally, the flow sensor can measure flowrate to help detect potential leaks in the filter 240 and in the filter compartment (not shown).

In another non-limiting example, the solar controller 245 may include one or more sensors 304 that can be designed to detect voltage, current, temperature, or a combination thereof. The power sensor can measure whether or not the solar controller 245 is connected to power, and/or whether it is activated. The voltage sensor can monitor the input voltage and detect any upstream electrical system faults. The voltage sensor can also measure the control voltage and verify the output signal to a solar valve actuator is within a functional range (e.g., ˜0-24V), and can verify the solar controller 245 relay voltage is within a functional range (e.g., ˜0-230VAC). The temperature sensor can be used to monitor an internal temperature of the solar controller 245 and identify if any internal components, including electronic components, are overheating.

In another non-limiting example, the one or more solar panels 285 may include one or more sensors 304 that can be designed to detect: power, voltage, current, solar radiation, or a combination thereof. The power sensor can measure whether or not the one or more solar panels 285 are activated. The voltage and current sensors can be used to detect power generation of the one or more solar panels 285. In addition to the data analytics techniques described herein, these measurements can be used to produce energy reports and historical usage data that can be displayed on the user device 120. A photosensor can be used to detect levels of solar radiation (i.e., is it a sunny day or a cloudy day?).

In another non-limiting example, the heater 250 may include one or more sensors 304 that can be designed to detect: power, voltage, current, temperature, pressure, or a combination thereof. The power sensor can measure whether or not the heater 250 is connected to power, and/or whether it is activated. The voltage sensor can monitor the input voltage and detect any upstream electrical system faults. The voltage sensor can also measure voltage drop to determine the power consumption of the heater 250. The current sensor can detect potential short circuits in the heater 250 by identifying abnormal power consumption and/or current spikes. The temperature sensor can be used to monitor the internal temperature of the heater 250 include the heating elements (not shown). The temperature sensor can also measure the temperature at an inlet and an outlet to verify the water temperature is being heated according to the heater 250 controls and settings. The pressure sensor can measure a differential pressure to identify scale or fouling through a water passage in the heater 250.

In another non-limiting example, the water quality monitor 220 may include one or more sensors 304 that can be designed to detect: power, voltage, flow, resistance, water chemistry, or a combination thereof. The power sensor can measure whether or not the water quality monitor 220 is connected to power, and/or whether it is activated. The voltage sensor can monitor the input voltage and detect any upstream electrical system faults. The voltage sensor can also measure a battery level if the water quality monitor 220 is battery powered or includes a battery pack. The flow sensor can also include a flow switch and can monitor water flow at an input and/or an output of the water quality monitor 220 and can identify potential clogs in the monitoring system. The flow sensor can further determine if the flow velocity is sufficient for proper operating conditions for the water quality monitor 220.

In another non-limiting example, the salt chlorine generator 215 may include one or more sensors 304 that can be designed to detect: power, voltage, flow, resistance, water chemistry, or a combination thereof. The power sensor can measure whether or not the salt chlorine generator 215 is connected to power, and/or whether it is activated. The voltage sensor can monitor the input voltage and detect any upstream electrical system faults. The voltage sensor can also measure a battery level if the salt chlorine generator 215 is battery powered or includes a battery pack. The flow sensor can also include a flow switch and can monitor water flow at an input and/or an output of the salt chlorine generator 215 and can identify potential clogs in the system. The flow sensor can further determine if the flow velocity is sufficient for proper operating conditions for the salt chlorine generator 215.

In another non-limiting example, the sanitizer 225 may include one or more sensors 304 that can be designed to detect: power, radiant energy, resistance, voltage, current, pressure, or a combination thereof. The power sensor can measure whether or not the sanitizer 225 is connected to power, and/or whether it is activated. In some embodiments, the sanitizer 225 is an Ultraviolet (UV) Light sanitizing device and a photosensor can be used to measure the radiant energy of the sanitizer 225 to also determine if the sanitizer is activated. The resistance sensor can determine the electrical resistance across the UV bulb to verify the bulb is properly installed and is within a functional range. Irregular resistance measurements can indicate a replacement bulb is recommended for the sanitizer 225. The voltage sensor can monitor an input voltage and detect any upstream electrical system faults. The voltage sensor can also measure voltage drop to determine the power consumption of the sanitizer 225. The current sensor can measure the current in the sanitizer 225 system to verify the circuit is working properly. Low or non-existent current measurements may indicate a replacement bulb is recommended for the sanitizer 225. The pressure sensor measures a differential pressure to detect scale or fouling through a water passage in the sanitizer 225.

In another non-limiting example, the pH regulator 210 may include one or more sensors 304 that can be designed to detect: power, voltage, current, level, chemistry, flow, or a combination thereof. The power sensor can measure whether or not the pH regulator 210 is connected to power, and/or whether it is activated. The voltage sensor can monitor the input voltage and detect any upstream electrical system faults. The current sensor can measure the current in the pH regulator 210 system to verify the circuit is working properly. Abnormal current measurements and/or an abnormal power consumption reading may indicate a malfunction. A chemical tank level associated with the pH regulator 210 can be measured by a level sensor, such as but not limited to: a float switch, force sensor, or similar. The chemical sensor can be used to identify chemical properties within the chemical tank. In some embodiments, one or more electrodes, or similar, may be used to measure a difference in the electrical potential between a pH electrode and a reference electrode. The flow sensor can include a flow switch and/or a fluid velocity sensor to measure a rate at which chemicals are dispensed through the pH regulator 210 system. In some embodiments the flow sensor may also be integrated with, or otherwise communicate with, the chemical sensor to measure the type and quantity of chemical(s) dispensed. In some embodiments an encoder may be used to measure, monitor, and/or detect the rotational position and velocity of a dispensing component of the pH regulator 210.

In another non-limiting example, the water feature 255 may include one or more sensors 304 that can be designed to detect: power, flow, pressure, or a combination thereof. The power sensor can measure whether or not the water feature 255 is connected to power, and/or whether it is activated. The flow sensor can include a flow switch and/or fluid velocity sensor, or similar, to measure the fluid/water flow rate through the water feature 255. The pressure sensor can be used to detect a water depth at a bottom surface of the water feature 255. The pressure sensor may also communicate with the flow sensor to measure the flow rate through the water feature 255.

In another non-limiting example, the pool cleaner 280 may include one or more sensors 304 that can be designed to detect: power, voltage, pressure, if debris should be emptied from the cleaner 280, or a combination thereof. The power sensor can measure whether or not the pool cleaner 280 is connected to power, and/or whether it is activated. The voltage sensor can monitor the input voltage and detect any upstream electrical system faults. The pressure sensor can measure a suction level in a suction line of the pool cleaner 280. An encoder can be used to detect if the one or more spinning motors of the pool cleaner 280 are rotating properly. As with the other system components 200 described herein, the monitored measurements may vary depending on the manufacturer and type of the pool cleaner 280.

In another non-limiting example, the pool skimmer 275 may include one or more sensors 304 that can be designed to detect pressure. A differential pressure sensor can detect if there is a clog in a skimmer basket of the pool skimmer 275 or if debris is interfering with air being induced in an equalizer line of the pool skimmer 275. In some embodiments, an encoder may be used to detect a position of a weir installed in the pool skimmer 275.

In another non-limiting example, the pool drain 265 may include one or more sensors 304 that can be designed to detect: temperature, flow, pressure, or a combination thereof. The temperature sensor can measure the temperature of the water output flowing through the pool drain 265. The flow sensor may include a flow switch and/or fluid velocity sensor, or similar, to measure the flow rate of water through the pool drain 265. The pressure sensor may measure a pool water level. The pressure sensor can also measure a differential pressure to detect if the pool drain 265 may be clogged.

In another non-limiting example, the pool light 260 can include one or more sensors 304 that can be designed to detect: power, voltage, current, temperature, resistance, or a combination thereof. The power sensor can measure whether or not the pool light 260 is connected to power, and/or whether it is activated. The voltage sensor can measure the input voltage to the pool light 260 and detect any upstream electrical system faults. The current sensor can measure the current through the pool light 260 and can be used with the voltage sensor to measure power consumption. The voltage and/or current sensor can also detect when there is an abnormal power consumption measurement, which may indicate a malfunction with the pool light 260. In some embodiments the pool light 260 may include one or more pool lights and can also include advanced lighting controls such as animation, color, dimming, timer controls, etc. The advanced lighting control features for the pool light 260 can include one or more sensors 304 to detect and measure system variables and/or operating parameters associated with the one or more lighting control features. In some embodiments, the resistance can also be measured to identify electrical shorts, faults, or when a light bulb or diode should to be replaced.

In another non-limiting example, the one or more valves 270 may include one or more sensors 304 that can be designed to detect: voltage, current, position, flow, or a combination thereof. The voltage sensor can monitor the input voltage and detect any upstream electrical system faults. The voltage sensor can also measure the control voltage and verify the output signal to a valve 270 actuator is within a functional range (e.g., ˜0-24V). The current sensor can measure the current in the one or more valves 270 system and detect if there is an abnormal current measurement. Abnormal current measurements and/or an abnormal power consumption reading may indicate a malfunction in the valve 270. The position of a valve 270 actuator and/or shaft can be detected using a position sensor, encoder, or similar. The flow switch can measure the flow rate through the one or more valves 270 and detect if a valve port is not receiving an expected flow.

In another non-limiting example, the other equipment 205 may include one or more sensors 304 that can be designed to detect one or more operating parameters associated with components of the other equipment 205 (e.g., power status, operational mode, flow, pressure, chemical composition, calibration status, and other parameters).

In one embodiment, the sensor 304 (including but not limited to any of the sensing components or monitoring devices discussed above) can collect and/or send one or more data sets associated with the operating parameters and historical data of the one or more system components 200 continuously, at scheduled intervals, or in response to a request or other system event. In this example, the request or system event can include a user input received by the user device 120. For example, if a user wanted to check the temperature of the pool or spa, the user device 120 could process this request and transmit a command for a sensor in communication with the pool or spa water, to collect the current temperature reading and transmit the information back to the user device 120 and process the one or more data sets to generate a display to be displayed on the user device 120.

FIG. 3 illustrates a system view of one embodiment of the central controller 110 in communication with the one or more system components 200, to illustrate an example of a connected system 300 for a system component device 302. As described in connected with FIG. 2, the system component device 302 can include an integrated sensor 304 or otherwise be connected to an external sensor 304. The central controller 110 can also, in certain embodiments, send and receive information regarding the system components 200 to the maintenance system 140 via the first network 130. The central controller 110 can also include a processor 306, a memory 308, a power supply 310, and a gateway node 312.

The memory 308 can be configured to store user record information or information received from the one more system components 200 and/or sensors 304, wherein the sensors can be coupled to, or in communication with one or more system components 200, or can be integrated with the one or more system components 200. The memory 308 can be implemented as a stand-alone memory unit and/or as part of the processor 306. In some embodiments, the memory 308 can be provided in the form of a database 430 (see FIG. 4) and/or as a lookup table, or other data storage configuration.

Furthermore, as one non-limiting alternative to the configuration illustrated in FIG. 3, the first network 130 can include a programmable processor 306 and/or a network interface (not shown) and can be electronically coupled to a memory 308 or database device (not shown). In some embodiments, the first network 130 can include program instructions that are stored on a cloud server non-transitory computer readable medium and that are executable by the programmable processor 306 to perform one or more of the methods described herein.

FIG. 4 is a block diagram of a maintenance system 140 of the connected aquatic monitoring system 100. The maintenance system 140 can include a server 400, one or more databases 430, one or more programmable processors and memory units (not shown), and one or more network interfaces 420. In some embodiments, the one or more programmable processors and memory units can be integrated into one or more of the other maintenance system 140 components including but not limited to, the server 400 and/or network interface 420. The network interface 420 may include any of the network configurations described in connection with the first network 130 and second network 150 in FIG. 1.

While the system components described include a server 400 and a network interface 420, it will be recognized by one skilled in the art that the system configuration could include one or more computing devices in several configurations. The computing elements of the maintenance system 140 can be provided via a one or more computing devices that may be arranged, for example, in one or more server banks or computer banks or other arrangements. Such computing devices can be located in a single installation or may be distributed among many different geographical locations. For example, the maintenance system 140 can include the computing devices that together may include a hosted computing resource, a grid computing resource, and/or any other distributed computing arrangement. The computing devices can further include one or more routers. In some cases, the maintenance system 140 can correspond to a dynamic computing resource where the allotted capacity of processing, network, storage, or other computing-related resources may vary over time.

In one embodiment, the maintenance system 140 is designed to process a one or more data sets using one or more data processing modules within the server 400. The maintenance system 140 server 400 can include: a diagnostic module 410, a deployment module 412, a notification module 414, a training module 416, an advanced analytics module 418, other data processing module, or any combination thereof. In some embodiments, the maintenance system 140 may include additional modules for processing and analyzing several data elements and data sets. As will be understood from the disclosure herein, the one or more data processing modules shown in FIG. 4 are exemplary. The maintenance system 140 may include any suitable number of processing modules (including a single processing module) for executing or carrying out any of the processes discussed herein.

In some embodiments, the one or more data sets can include: system component data 432, user data 434, third-party data 436, system data 438, other data 440, or any combination thereof.

In some instances, the maintenance system 140 receives transmitted data including system component data 432, which can include one or more of manufacturer, model number, serial number, unique identification code, size and/or capacity, volume, parts list, warranty or protection information, installation information, geographic location, date installed, recommended maintenance procedures and timelines, and normal operating thresholds, warning codes, or any combination thereof. In some embodiments the maintenance system 140 can receive or retrieve additional system component data 432 from the manufacturer of the system component 200 including maintenance procedures, maintenance timelines, recommended corrective action, operational instructions, configuration or setup instructions, other instructions, tasks, rebates, recalls, common issues, or other data. The system component data 432 can further include the operating parameters and/or data obtained from the one or more sensors 304 described for the individual system components 200 in the description for FIG. 2, although the operating parameters and/or data is not limited to these examples. Additional data can be collected, including specific service repairs and maintenance history for specific system component 200.

In some embodiments, the maintenance system 140 receives transmitted data including user data 434, which may include but is not limited to: personal information about the user, contact information, address, a list or log of the user's specific system components 200, maintenance history information, secondary contact information, payment information, promotional codes, any notes regarding previous service requests (e.g., gate access code, preferred service days/time, previous service technician notes etc.), and other information. In one embodiment, the user data 434 can be updated to include notification and communication preferences, settings, and historical usage data for a specific user, including call logs and service history. In some embodiments, the maintenance system 140 can receive and/or retrieve additional information uploaded to the connected system 100 via the first network 130, where the additional information may include, but is not limited to, photos and descriptions (e.g., of one or more devices 200) uploaded to the maintenance system 140 to aid in diagnostics, service, or repair.

A third-party system 160 may obtain access to the user-uploaded information stored in the maintenance system 140 via the second network 150 to help facilitate service. In this example, additional authentication processes may be used before providing access to the third-party system 160. In some embodiments, a third-party system 160 can transmit and/or upload information to the maintenance system to be associated with the user's specific system components 200, for example, photos after a service request is completed and/or notes from a technician or third-party servicer regarding parts and/or post-service summary report and/or other aspects of the service request. In some embodiments, the post-service summary report can be generated automatically by one or more processes described with the maintenance system 140.

In some embodiments, the maintenance system 140 receives transmitted data including third-party data 436, where the third party may be a third-party servicer or dealer. The third party data 436 may include but is not limited to information about the third-party, brands serviced, repair and service capabilities, profile information including descriptions regarding service and request handling techniques and priorities, invoicing and payment information, contact information, address, geographical regions located and/or serviced, a list or log of the third-party's specific system components 200 issues completed, maintenance history information, maintenance procedures and timelines, manufacturer identifier or information, part supply, number of available technicians, certifications, scores, and other information. In one embodiment, the third-party data 436 can be updated to include notification and communication preferences and settings and historical usage data for a specific user or servicer or technician, including call logs, denied service requests, and service history.

When used throughout the disclosure, one skilled in the art will recognize that “dealer” can include, but is not limited to, a third-party servicer capable of providing service, parts, and/or technician(s) to assist a user in the repair or replacement of system components 200 or routine maintenance. Similarly, a “technician,” when used throughout the disclosure, can include an individual performing one or more configuration or service tasks on the connected system 100. In some embodiments, a technician may work for a dealer or other third-party servicer.

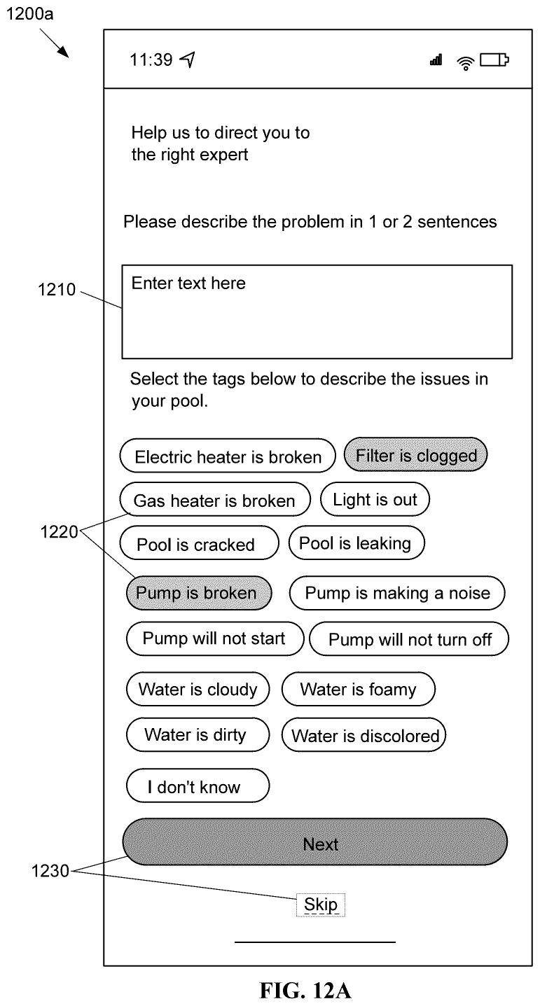

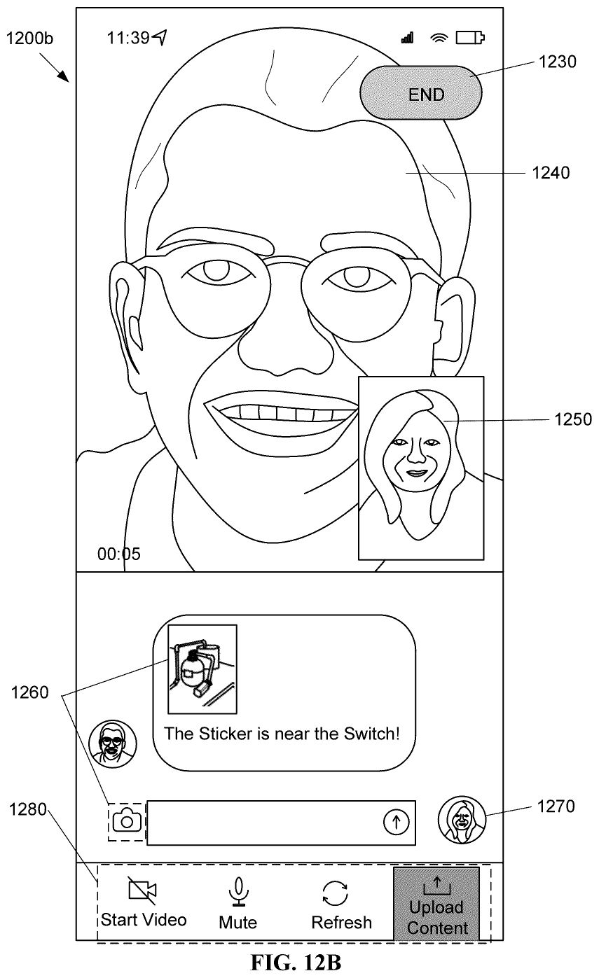

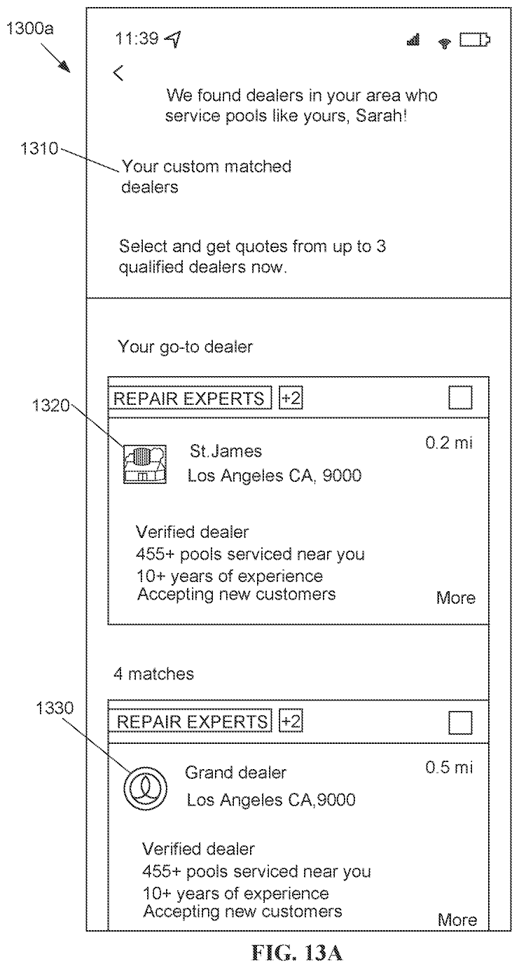

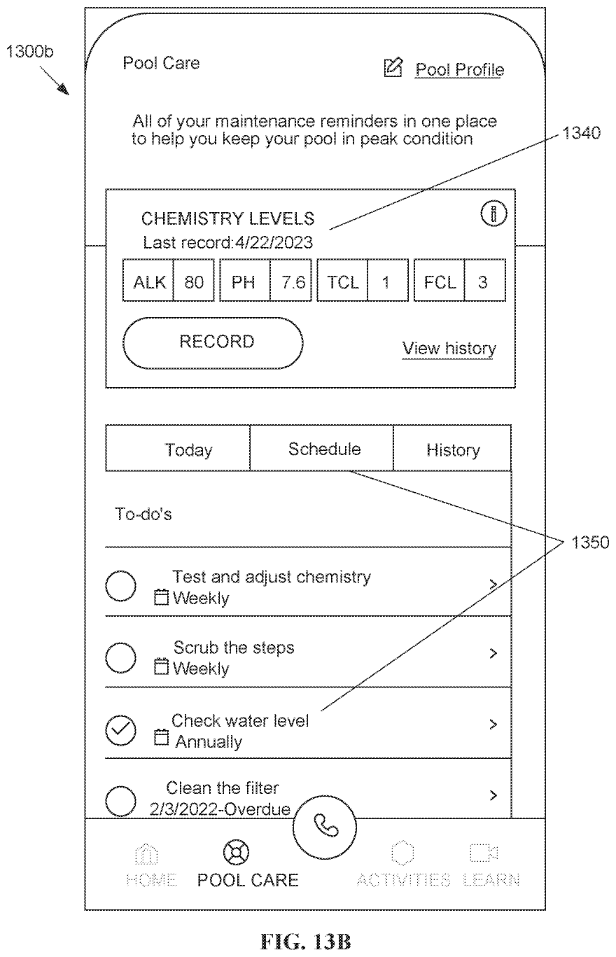

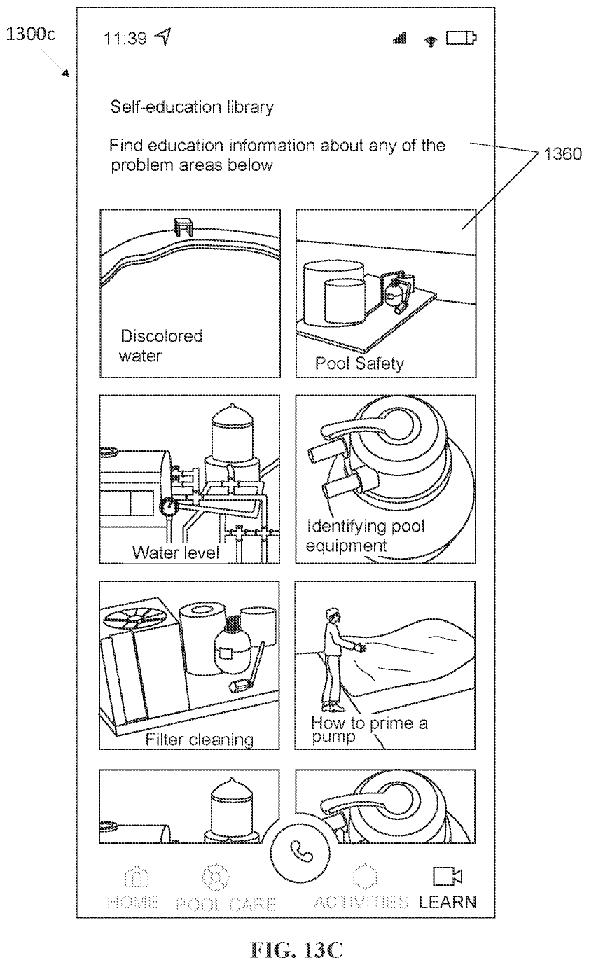

In one embodiment, a third party can install an application on an electronic device or otherwise integrate the third-party system 160 with the maintenance system 140. A third party can set up a record (e.g., dealer record) when the third party is an authorized servicer or dealer related to one or more of the one or more system components 200. In some embodiments, the third-party data 436 can be updated in the maintenance system as a third party updates the information in the third-party record. A user can also authorize one or more third parties to obtain access to some aspects of the user's record information stored in the maintenance system 140, as described in more detail in connection with FIGS. 12B and 13A.

In some embodiments, the maintenance system 140 receives transmitted data including system data 438, which may include but is not limited to the status, health, and connection of the several aspects of the connected system 100, including the connectivity information between each of the devices and network interface(s). The system data 438 may further include troubleshooting or general questions regarding the user or third-party interface, separate from the diagnostic aspects related to the system components 200. The system data 438 may further include information related to dropped calls, error logs, or other data.

In some embodiments, the maintenance system 140 receives transmitted data including other data 440, which may include one or more data sets not described in connection with the other transmitted data categories described, including historical information, usage reports, engagement information, parts supply, or any other data that may be used by the maintenance system 140 or other aspects of the connected system 100.

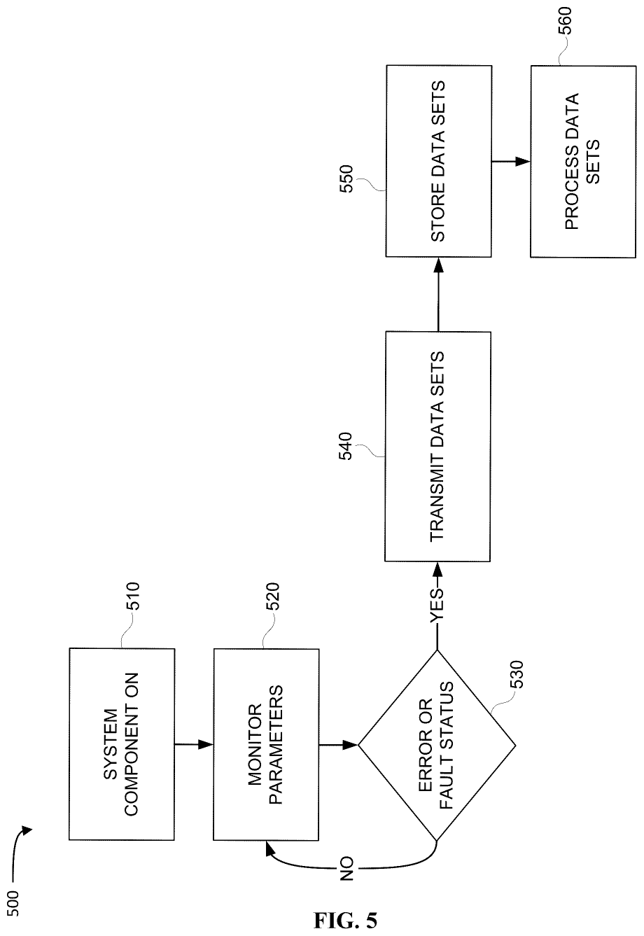

The maintenance system 140 utilizes the processes illustrated in FIGS. 5-11 and described below to transform the data sets into customized outputs, in part, using advanced analytics and diagnostic tools.

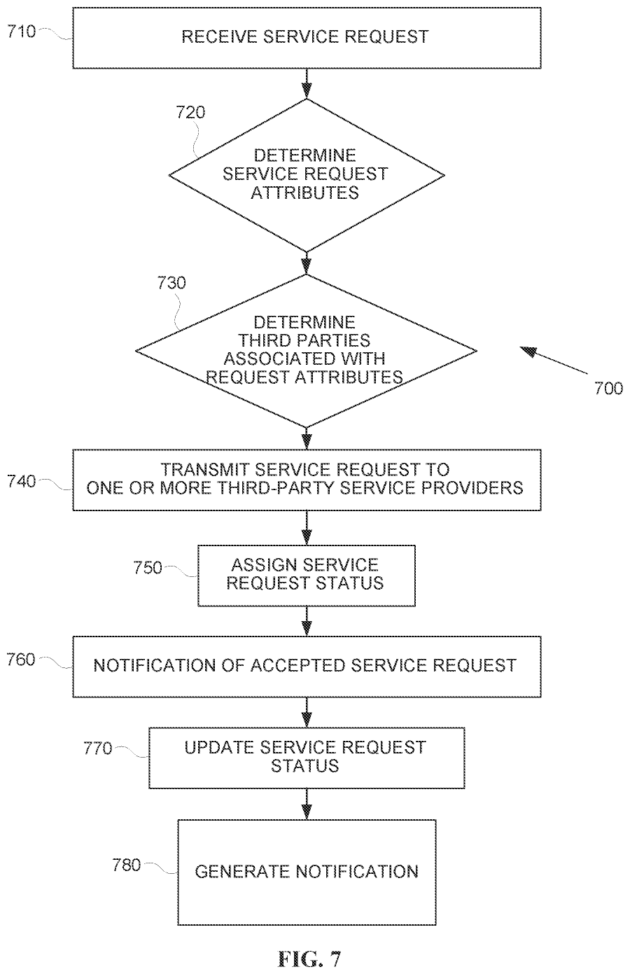

The diagnostic module 410 can be configured to receive and/or retrieve data sets from the sensor and monitoring devices of the connected system. The diagnostic module 410 can be further configured to compare the one or more data sets to threshold values or ranges. In some embodiments, the data sets compared by the diagnostic module 410 include the system component data 432 and user data 434 but can include any combination of information from the one or more databases 430. FIG. 6 describes the process for processing and analyzing the one or more data sets using the diagnostic module 410, in more detail, including options to remotely troubleshoot system components 200, assist the user in self-diagnostics and/or self-repair, order replacement parts, and/or deploy a request to a third party utilizing the deployment module 412 described below and in connection with FIG. 7.

The maintenance system 140 may further include a deployment module 412 for efficiently distributing requests to one or more third parties. In at least one embodiment, the deployment module comprises one or more location monitoring components and parameter validators to compare diagnostic information generated by the maintenance system 140 and the diagnostic module 410, with the third-party data 436. As described in detail in relation to FIG. 7, the deployment system is configured to identify the data items associated with a new request, process those data items to determine specific request attributes or parameters, and identify an appropriate third-party servicer to receive a notification for the request, based on a combination of third-party servicer capabilities, proximity, and characteristic score.

In some embodiments, the characteristic score can include a rating associated with the third-party service provider. The rating can be based in part on customer reviews, inventory, years in operation, number of locations, response time, availability of technicians, weekend or evening service hours, etc. In some embodiments, the characteristic score can be adjusted based on the one or more attributes of the service request. For example, a characteristic score for a third-party servicer nearby the user's location may be higher than a third-party servicer in a neighboring town. In another example, a characteristic score for a particular third-party service provider specializing in the brand of system component(s) owned by a user may be higher than a service provider who is closer in location but does not routinely service the user's specific type of system component(s). Further, the characteristic score can be automatically adjusted using one or more emphasis values based on user settings or preferences (e.g., preferred service provider, availability for a service call, locally-owned business, female-owned business, etc.).

The notification module 414 can be used for creating, modifying, and logging events and system updates for the maintenance system 140 and the connected system 100. The notification module 414 can also generate, update, and push notifications and customized alerts to one or more devices or applications for the user and/or the third-party. In one embodiment, the notification module 414 is configured to be dynamic, scalable, and integrated with one or more third-party systems 160. In some embodiments, the notification module 414 is configured to receive one or more data sets from one or more data sources or applications, generate one or more notifications, and handle the distribution of the one or more notification to the applicable data sources, applications, user devices 120, third party systems 160, or a combination thereof.

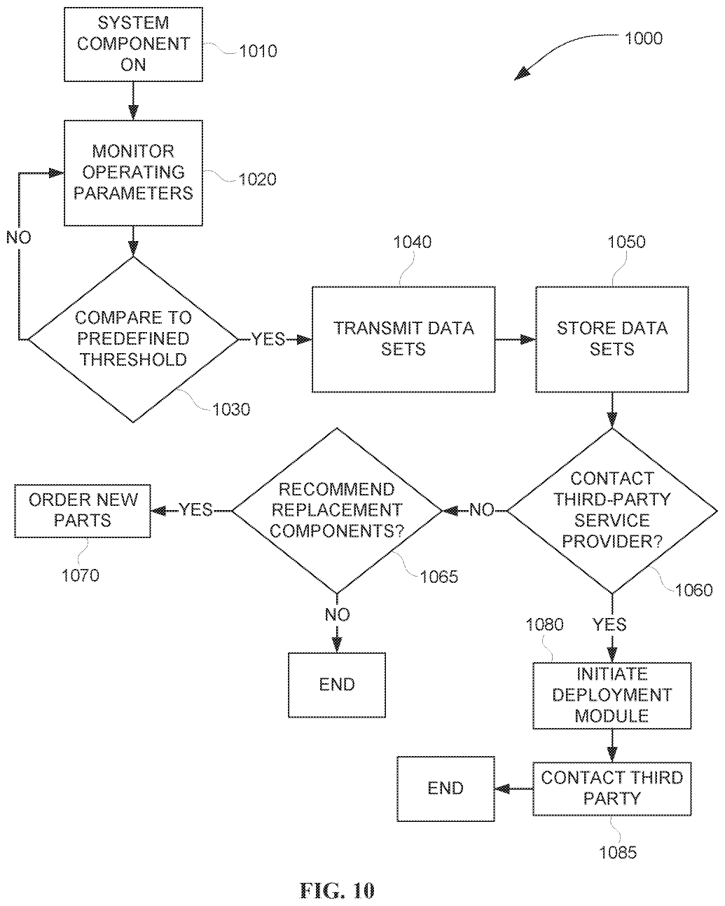

As described with respect to FIG. 10, the notification module 414 can be configured to create and monitor new events, wherein each event can be assigned a unique identification tag and time stamp. A notification status can be updated automatically via the maintenance system 140, or in response to receiving a user input, third-party input, or other indication that an event has been modified.

The training module 416 is designed to execute programmable instructions related to one or more data analysis and modeling processes. In one example, the training module 416 generates and iteratively trains training modules for providing dynamic outputs. For example, in some embodiments the training module 416 can be configured to perform one or more of the several comparing and determining steps of the processes 500 - 1100 shown and described in connection with FIGS. 5-11. The training module 416 can be configured to generate, train, and execute one or more nodes, neural networks, gradient boosting algorithms, mutual information classifiers, random forest classifications, and other machine learning and artificial intelligence related algorithms.

The advanced analytics module 418 can execute additional data processing techniques and steps, including but not limited to: report generation, troubleshooting help, customized user display content and/or recommendations, historical data, usage data, and other analytics. The advanced analytics module 418 can also be used for relationship handling processes including automated reminders, call scheduling, feedback, and other data processing tasks.

FIG. 5 illustrates a monitoring process 500 for monitoring the operation, health, and status of the one or more system components 200. At step 510, a system component 200 can be turned on, or detected as already being powered on by one or more sensors 304. At step 520, the one or more sensors and/or central controller 110 can monitor at least one operating parameter of the system component 200. Operating parameters can include, but are not limited to, the operating data measured and described in connected with FIG. 2. At step 530, the one or more sensors and/or the central controller 110 can determine that a system component 200 is malfunctioning, is operating outside of a predefined acceptable operational range, or has generated an error, warning, maintenance reminder, or similar. If an error code is detected, at step 540 the data sets are transmitted to the maintenance system 140 for storage and analysis and processing at steps 550, 560, respectively. If an error code is not detected at step 530, the monitoring process 500 returns to step 520 and continues to monitor the system components 200.

In some embodiments, the one or more data sets measured by the one or more sensors 304 can be automatically and continuously transmitted to the maintenance system 140 and the determining step of 530 can be performed by the maintenance system 140 and the associated diagnostic module 410. In other instances, the one or more data sets measured by the one or more sensors 304 can be transmitted to the maintenance system 140 over set period or intervals (e.g., every 10 minutes, every 30 minutes, every hour, every twenty-four hours, every week, every month, and the like). In further instances, the one or more data sets measured by the one or more sensors 304 can be transmitted to the maintenance system 140 and the determining step of 530 can be performed by the maintenance system 140 and the associated diagnostic module 410 independent of the error code status detected at step 540.

In another embodiment, the user can request an operating parameter reading for a particular component using a user device 120. In this example, the monitoring system 500 sends the data sets at step 540, even if an error code is not detected at step 530. If there is no error and no user request, the monitoring system 500 can continue to monitor the system components at step 520.

FIG. 6 illustrates a diagnostics process 600 for identifying malfunctions or irregular operating parameters in equipment and system components 200 and providing customized recommendations to users and third-parties. At step 610, a system component 200 can be turned on, or detected as already being powered on by one or more sensors. The one or more data sets transmitted to and processed by the maintenance system during the monitoring process 500 can be received in step 620 by the system diagnostic module 410. In some embodiments, the processed data set(s) can be added to a modified, updated, or additional data set(s) and stored by the maintenance system 140.

The data sets can include one or more operating parameter value(s), including any of the user data 434 and/or operating data described in connection with the system component data 432, described in FIG. 4. At step 630, the operating parameter value(s) including the one or more data sets are compared to a predefined threshold value associated with a normal operating range. The predefined threshold values can be set initially by the maintenance system 140 using the manufacturer's recommendation and can be altered with authorized access to the maintenance system 140, as determined by successful authentication. If the operating parameter values do not exceed the threshold value(s), the diagnostic module 410 can return to step 620 and wait for a new input from the maintenance system 140 indicating that there may be an error or malfunction. If the threshold has been reached or are out of context (or above or below a predefined threshold for the functional range or acceptable operational range), the maintenance system 140 can generate notifications, warning messages, or alerts that may be displayed locally on the user device 120. In some embodiments, the notification module 414 can generate and transmit the notifications, warning messages, or alerts to display on one or more display interfaces and/or user devices 120.

At step 640, the maintenance system 140 determines if the recommendation includes third-party service, replacement parts, user self-repair, remote restart of the equipment, adjusting one or more operating parameters and/or device settings, or another customized recommendation. If the solution includes a recommendation for third-party service or repair, an alert is generated and pushed to the user at step 650. This alert can include data specific to the user record associated with the system component 200 and can further include recommended video tutorials customized to the specific component 200 installed in the user's connected system 100, if the solution is a recommended user self-repair. Additionally, at step 650, a notification can be generated to provide the user with a summary of the diagnostic module 410 analysis and recommended next steps. In some examples, the summary of the diagnostic module 410 can be generated automatically and can include additional information as part of recommended next steps, as described in connection with the interface graphics of FIGS. 12A-13C.

In some embodiments, the recommended next step may include a remote start or restart at step 660. In this example, at step 670 the maintenance system 140 can transmit instructions via the first network 130 and/or the central controller 110 to restart the system component 200. Once the restart has been initiated, as detected by the one or more sensors, the maintenance system 140 can send an additional command to power on the system component 200.

If the outcome of step 640 determines that third-party service or repair is recommended, a customized notification alert can be generated at step 645. At step 655, if the outcome of the deployment module 412, described in detail in connection with FIG. 7 below, results in a third-party match between a dealer with the capability and part supply to address the user's issue, a notification is generated and sent to both the third party at 675 and to the user at step 680. If the output of the deployment module 412 does not result in a recommended match, a customized notification can be generated and pushed to the user with a summary of the analysis and recommendation for next steps at step 665.

FIG. 7 illustrates a deployment process 700 for distributing a service request submission according to one or more attributes of one or more of the multiple data sets contained in the service request. In some embodiments, the one or more attributes can include at least one or more of the unique identification code of the system component, the operating parameters, an error code, a time stamp or other historical log information, diagnostic information, the recommended corrective action, or other information or data associated with the system component.

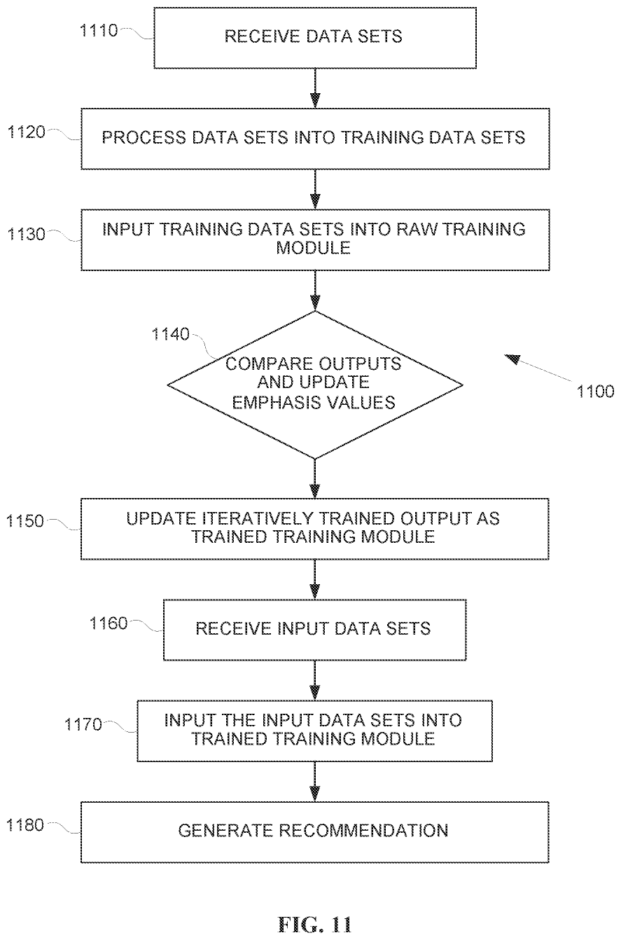

The deployment process 700 may be initiated by the system when a request submission is received from a user, for example using a user device 120, as shown in connection with FIG. 11. The deployment process 700 can also be initiated when a service request is recommended based on steps 640, 840, or 1060 of FIGS. 6, 8, and 10, respectively. The deployment process 700 may include a deployment sequence configured to efficiently process, manage, and distribute service requests to one or more third-party systems 160 based on one or more characteristics.

In one embodiment, the deployment process 700 helps identify the attributes associated with a particular request, as determined by the one or more data sets stored in the database 430 associated with the system component data 432 and the unique identification information of the user data 434. In one example, the one or more data sets associated with the unique identification information of the user record may include settings for a particular record that apply to every request submitted for the user record. In another example, the one or more data sets associated with a service request may include one or more attributes specific to a particular request and not necessarily associated with other requests submitted by the same user record.

The deployment process 700 helps identify third parties with specific characteristics to fulfill one or more request attributes. These characteristics may include, but are not limited to, a third-party servicer's: skill(s), specialty, available services, brands serviced, part supply, availability, geographic location, and available languages. The characteristics may additionally include information stored as third-party data 436 in the one or more databases 430 (see FIG. 4). By utilizing a dynamic and advanced analytics system for providing a recommendation for eligible and available third parties to fulfill a service request, the deployment process 700 helps facilitate an efficient request handling system to minimize cancellations and appropriately allocate available and qualified resources.

Beginning at step 710, the maintenance system 140 receives a new service request submission via a user device 120, or from the outcome of the diagnostic module 410. The new service request can include one or more data sets associated with fields of a request form and/or settings from a user record the request was submitted from or on behalf of. Also at step 710, the one or more data sets are stored in the database 430 and the deployment process 700 is initiated.

At step 720, the deployment system 700 requests the data sets associated with a service request from the database 430 and extracts the one or more data sets associated with specific attributes of the service request. In some embodiments, the data sets used in the deployment system 700 and transmitted to one or more third-party systems 160 are processed data sets. In some embodiments, the deployment process 700 may be initiated after the one or more data sets associated with specific attributes are extracted by the maintenance system 140 and/or a third-party system 160. In one embodiment, the specific attributes are processed to extract one or more of the characteristics described above, wherein the characteristics correspond to attributes saved in the database 430 as third-party data 436 associated with one or more third parties.

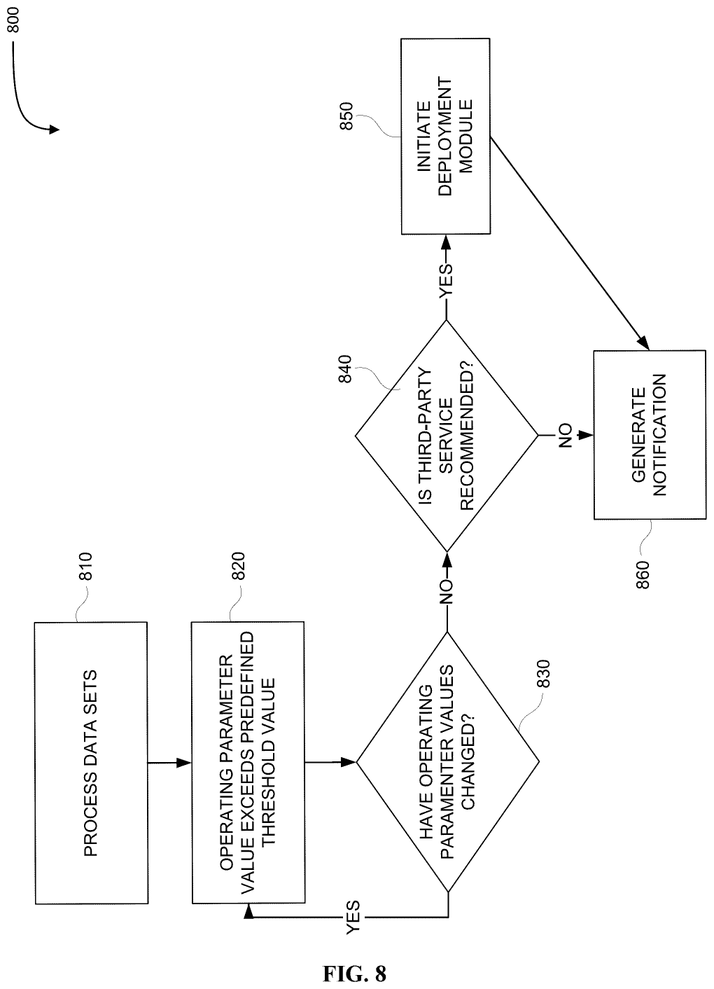

At step 730, the deployment system 700 compares the one or more data sets associated with the attributes of the service request to the third-party attributes saved in the database 430 as third-party data 436 and identifies which third parties can fulfill the service request specifications. At step 740, the deployment system 700 receives a service request notification via a notification module 414, for example, at step 860 in FIG. 8 described below, and transmits the request notification to the one or more third parties that match the request specifications. In some embodiments, the deployment system 700, or other systems described herein, may implement one or more application programming interfaces (APIs) and data processing techniques. In this way, in at least one embodiment, the system discussed herein is a dynamic data analytics system and may transmit transformed data and processed information to the notification module 414 via an API, wherein the notification module 414 can transmit a notification to the one or more third-party systems as determined by the outcome of the deployment process 700, in one example.

The deployment process 700 can further include a deployment sequence that is initiated at step 740. The deployment sequence can utilize an advanced analysis technique to determine a value associated with each third-party system 160 in communication with the connected system 100 and the maintenance system 140. The value may be associated with a number of the characteristics described above, for each third party who can provide the parts and/or service indicated in the request attribute. In one example, the deployment sequence requests and transmits an initial request notification to any number of third parties identified with the ability to fulfill a service request. In this example, the initial request notification is transmitted to the third parties within a specific radius of the location indicated for the service request (based on, for example, a geographic location of the one or more system components 200 as indicated by, or received from, a central controller 110 or user device 120), or a service location radius indicated in the third-party data 436 associated with a particular third party. In another embodiment, the initial request notification may be transmitted to a third party designated as a preferred service provider as stored in the user data 434 and/or within the user's record settings. If the initial request notification is acknowledged and accepted by a third party, the deployment sequence may terminate the initial request notification to the other third parties who received the initial service request and send a status update request to the notification module 414.

If the initial request notification is unanswered for a specified period of time, the deployment process 700 may request and transmit a second request notification. The second request notification can either be transmitted to the same third parties as the initial request notification, or the deployment system may expand the location distance to identify additional third parties that could fulfill the service request. This process at step 740 can be repeated for an expanding radii or other factors until the service request notification is accepted.

Once the service request notification is transmitted, at step 750 the deployment system 700 communicates with the notification module 414 to assign a “pending” status to the request. Once the service request notification has been accepted by a third party, at step 760 the deployment system 700 communicates with the notification module 414 to update the request status to “confirmed.” In one embodiment, when the deployment system 700 updates the request status at step 770, a notification can be generated at step 780 and transmitted via the notification module 414, to indicate the request has been confirmed by the third party. In several embodiments, the unique identification information associated with the service request is linked to the unique identification information associated with the third-party record of the service provide, and this information is stored in the database 430.

In some embodiments, if the third party subsequently cancels the request, the deployment process 700 will start over, the system will receive a cancellation notice and will update the request status to “pending” at step 770 until a new third party accepts the service request. In this example, the deployment sequence will exclude the third party who previously cancelled the request, in the subsequent transmittals of the service request notification. In some embodiments, the maintenance system 140 can record a history of service requests denied and/or cancelled by a third party and store the information in the third-party data 436.

In one embodiment, the deployment system may transmit the initial service request notification only to the third party with the highest value, and then transmit a second notification to the third party with the second highest value if the third party with the highest value fails to accept the service request within a specified time. In this example, the value can be calculated by evaluating a number of the different characteristics, including but not limited to: distance of the third party from the request source, part supply, specific brands of system components 200 services, and rating of the third party. Wherein a shorter distance from the third party to the request source will result in a higher value, and a higher rating of the third party will result in a higher value. If a particular third party does not have the part(s) available or service the particular brand of system component 200 in the request specification, the third party may be excluded from the deployment process altogether. Scores of the third party may be associated with feedback and manual evaluations of service by users, through objective monitoring of completion time, number of available attributes, engagement with the connected system 100, or several other factors.

FIG. 8 illustrates a third-party notification sequence process 800 for generating a service request notification for a third-party system 160, wherein the third-party notification sequence process 800 is executed by the notification module 414 and can be integrated with the connected system 100. In some embodiments, the third-party notification sequence 800 is used to complete the notification transmission step (i.e., step 740) of the deployment process 700, described in connection with FIG. 7. In one embodiment, the third-party notification sequence process 800 can be used to generate one or more leads for a third-party system 160 and customized work order requests notifications can be generated and transmitted for display on one or more devices of a third-party system 160. As described above, the notification module 414 can also communicate and/or integrate with one or more user devices 120 to generate and transmit notifications related to events other than those generated by the connected system 100, including the user notification sequence 1000, described in connection with FIG. 10 below.

Beginning at step 810, the maintenance system 140 receives one or more data sets and can process the one or more data sets using the diagnostic module 410 (or other data processing modules of the connected system 100) and the diagnostic process 600 described in connection with FIG. 6, in one non-limiting example. In step 820, when there is indication that an operating parameter value exceeds (or otherwise falls outside of the range), a predefined threshold value for that operating parameter, as can be determined by step 630 of the diagnostic process 600, the notification sequence 800 can then monitor the operating value at step 830 to determine if the value changes. A value may change, for example, if a remote start operation in step 660 of FIG. 6 is initiated, or if a user makes adjustments to the system component 200 during the diagnostic process 600.

If the third-party notification sequence process 800 at step 830 determines that the operating parameter values have not changed and/or that the operating parameter value(s) continues to exceed the predefined threshold value as determined by step 820, the third-party notification sequence process 800 can communicate with the diagnostic module 410 and the output of step 640 of FIG. 6, to determine if a third-party service call or technician is recommended to address the issue. In one embodiment, if the maintenance system 140 determines that a third party is recommended to repair the issue at step 840, the third-party notification sequence process 800 can initiate the deployment module 412 in step 850, using the deployment process 700 as described in connection with FIG. 7. In this example, the third-party notification sequence process 800 can generate a user notification at step 860 according to the user notification sequence process 1000 described in connection with FIG. 10 below to alert the user that a service request has been transmitted. In some embodiments, the system can leverage one or more APIs and data processing techniques to produce customized outputs and the third-party notification sequence process 800 may communicate with one or more third-party systems 160 via APIs.

In one embodiment, if the maintenance system 140 determines that a third-party servicer is not recommended to repair the issue at step 840, the third-party notification sequence process 800 can generate the user notification at step 860 according to the user notifications sequence process 1000, described in connection with FIG. 10 below. In one example, the maintenance system 140 may provide a diagnostic summary and/or recommended actions to be performed by the user to self-repair the issue in lieu of a third-party technician or other service provider. In this example, the user may submit a service request using one or more user device(s) 120 rather than performing self-repair on the system components 200.

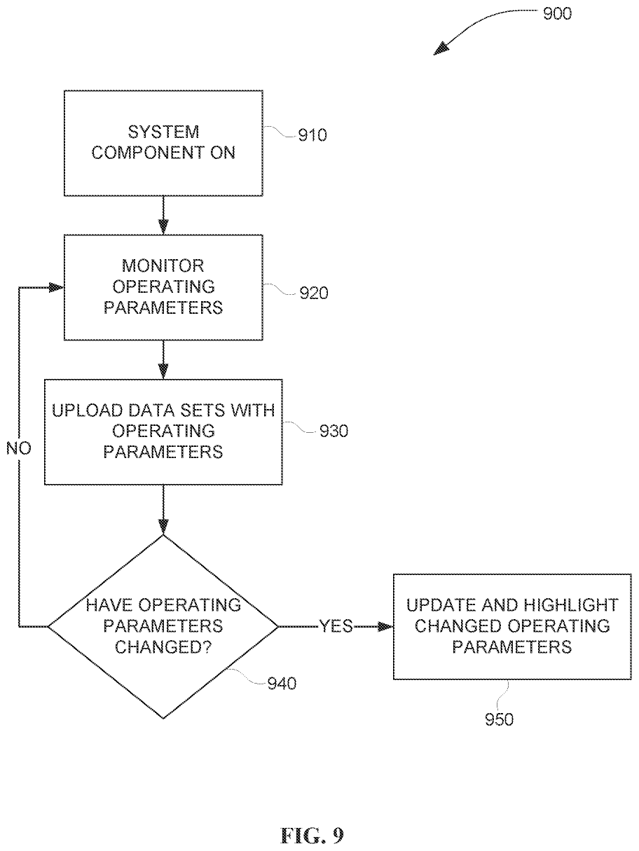

FIG. 9 illustrates an operating parameter update process 900. At step 910, a system component 200 can be turned on, or detected as already being powered on by one or more sensors. At step 920, one or more sensors can monitor one or more operating parameters associated with the system component 200. Operating parameters can be included in one or more data sets and can include any of the user data 434 and/or operating data described in connection with the system component data 432 of FIG. 4.

At step 930, the operating parameters including the data sets are transmitted to the maintenance system via the first network 130. In some embodiments the operating parameters can be sent and/or stored in one or more user devices 120 and the central controller 110. The transmitted operating parameters are saved in a database 430 of the maintenance system 140. The maintenance system 140, in step 940 can determine if the operating parameter values have changed by comparing the previous data set transmitted for the system component 200 to the newly transmitted data set. In an alternative embodiment, the central controller 110 can internally store the operating parameter values and can determine if the operating parameter values have changed prior to transmitting the values to the maintenance system 140 at step 930. In some embodiments, one or more data processing modules of the connected system 100 can process the data sets and/or extract one or more data elements in one or more of the comparing, determination, and/or analysis steps of the processes described herein.

In one embodiment, one or more tolerance windows can be selected to allow for some fluctuation in the operating parameter values that would not be determined to be a change in the operating parameter value. Thus, in some examples, the operating parameter values are not considered to have changed if the amount of change is within a tolerance window. In some embodiments, the tolerance window can be set by a user, a manufacturer, or a third party. If the operating parameter values have not changed, the one or more sensors can continue to monitor the operating parameters associated with the system components 200 at step 920. If the operating parameters have changed, the maintenance system 140 can be updated at step 950. In some embodiments, the changed operating parameters can be highlighted or otherwise flagged so that when a user or a third party accesses the operating parameters in the maintenance system 140 or through the connected system 100 components, the changed operating parameters can be quickly identified and evaluated. In some embodiments, the maintenance system 140 can push an alert and/or notification message to a user device 120 or a third-party system 160 when one or more operating parameters change. In one embodiment, the maintenance system 140 can push an alert or notification message using the third-party notification sequence process 800 and/or the user notification sequence process 1000, described in connection with FIGS. 8 and 10, respectively.

FIG. 10 illustrates a user notification sequence process 1000 for generating notification for one or more user devices 120. In one embodiment, the user notification sequence process 1000 can be used to generate notifications related to, but not limited to: maintenance reminders, alerts regarding operating parameters of the one or more system components 200, and other notifications as described in steps 645, 650, 665, 680, 780, and 860 in FIGS. 6, 7, and 8, respectively.

At step 1010, a system component 200 can be turned on, or detected as already being powered on by one or more sensors. The one or more data sets transmitted to and processed by the maintenance system 140 the diagnostic process 600 can be received in step 1020 by the notification module 414 and operating parameters of the system components 200 can be monitored using, in one example, the monitoring process 500.

At step 1030, the operating parameter value(s) including the data sets are compared to threshold values for a normal operating range. The threshold values can be set by the maintenance system based on a manufacturer's recommendation and can be altered with authorized access to the maintenance system 140. If the operating parameter values do not exceed the threshold (or are otherwise outside of the acceptable range), the diagnostic module 410 and/or notification module 414 can return to step 1020 and wait for a new input from the maintenance system 140 indicating that there may be an error or malfunction. If the threshold has been reached or is out of context (or above or below a predefined threshold), the maintenance system 140 will transmit the data sets to the maintenance system 140 at step 1040 and store the data sets in a database 430 at step 1050.

At step 1060, the maintenance system 140 determines if the recommended corrective active action for an identified issue includes third-party service, replacement parts, user self-repair, remote restart of the equipment, adjustment of one or more operating parameters or device settings, or another corrective action. If the recommendation does not include third-party service or repair, an alert is generated and pushed to the user according to the notification process 800. This alert can include data specific to the user record associated with the system component 200 and can further include recommended audio and/or video tutorials customized to the specific component 200 installed in the user's connected system if the solution is a recommended user self-repair. At step 1065, the maintenance system 140 can determine if the self-repair or diagnosis recommends new or replacement parts to resolve the issue. If the system 1000 determines at step 1065 that replacement components should be ordered to complete the recommended user self-repair, the system can automatically order new parts at step 1070. In some embodiments, the new parts and/or system components can be sent to a user's location and/or to the geographic location of the one or more system components 200.

If the system determines at the outcome of step 1060 that third-party service or repair is recommended, a customized notification alert can be generated according to the notification process 800 and the user notification sequence can initiate the deployment module 412 and deployment process 700 at step 1080, as described in connection with FIG. 7. The notification sequence 1000 can contact the third-party recommended from the deployment process 700 at step 1085. In one embodiment, if the diagnostic process 600 determines that replacement components should be ordered to complete the service request, the user notification system 1000 can be notified to order replacement components at step 1065 for the third-party servicer to utilize in the fulfilment of the service request. In some embodiments, the system can leverage one or more APIs and data processing techniques to produce customized outputs and the user notification system 1000 may communicate with one or more user devices 120 via APIs.

FIG. 11 illustrates a training process 1100 for iteratively training a deployment module 412, where the training process 1100 can be configured to perform several advanced data analysis and modeling processes. In one example, the training process 1100 generates and iteratively trains training modules for providing dynamic deployment and request matching recommendations for third-party dealers or other professionals who can provide service on a user's system component 200 according to the output of the diagnostic module 410. For example, the process 1100 can be configured to generate, train, and execute one or more nodes, neural networks, gradient boosting algorithms, mutual information classifiers, random forest classifications, and other machine learning and artificial intelligence related algorithms.

At step 1110, the system receives (or retrieves from one or more databases 430) one or more sets including a known characteristic or parameter value that is used to iteratively train one or more raw training modules to create one or more trained training modules.

At step 1120, the system can input a data set of the one or more data sets as a training data set, or multiple training data sets. In step 1130, each of the training data set(s) are input into a raw training module based on the data type associated with the one or more data sets. In one non-limiting example, this allows the system to iteratively train the training modules based on multiple data sets of different data types, including data provided by specific user records or specific service request types.

At step 1140, the output can then be compared to the known characteristic value(s) for the input training data set. One or more nodal emphasis values of the system can be updated for one or more nodes within the raw training modules based on the results of the comparing step, in order to iteratively train and improve the training module in step 1150.

At step 1150, when the output of the raw training module(s) is within a predefined threshold of the known characteristic values for the input training data sets, as determined during the compare step of 1140, the one or more raw training modules are output as trained training modules.

The system in step 1160 can receive and process one or more input data sets associated with a specific service request type, wherein each of the one or more input data sets have several data sets. In one embodiment, a specific service request type may have several associated input data sets. In step 1170, the system can input each of the one or more input data sets through a trained training module based on the service request type.

The system in step 1180 receives one or more characteristic values as outputs from the one or more trained training modules. In at least this way, system can utilize one or more trained training modules to output specific recommendations tailored to certain characteristic values. In one example, if a request has a characteristic value based on specific brands of system components a third-party dealer is capable of servicing, the system can use a training module based primarily on the characteristic value of the brand of the system component(s) that are in the service request. Alternatively, the system could also utilize a combination of several training modules where the component brand is one of several characteristic values, in addition to a distance from the service request source, wherein the process 1100 can recognize and provide a recommendation based in part on user record settings stored in the one or more data sets associated with user data 434. For example, the process 1100 may evaluate a specific service request type and display a recommendation for a third-party that has a low stock of the components noted for the service repair, but that meets the basic service request parameters and is saved within a user record's preferred third-party dealer list. It will be appreciated by one skilled in the art that a combination of several characteristic values can be used in a training loop to provide a customized deployment recommendation based on a high level of certainty.

In step 1180, the system determines a deployment recommendation based on the characteristic value(s) and modifies a display and/or generates a custom notification based on the deployment recommendation(s).

Also, the system can include one or more secondary metrics as parameters in one or more processes to iteratively train a training module or several training modules. When used throughout the present disclosure, one skilled in the art will understand that processes for “iteratively training the training module” can include machine learning processes, deep learning processes, and other forms of artificial intelligence processes. For example, the system and processes of the present disclosure can perform diagnostics, generate call schedules, provide customized recommendations according to user record settings and preferences, generate custom reports, and similar processes. In some embodiments, the system may use additional inputs and/or feedback loops to an iterative training process for a deployment recommendation based on one or more service request parameters and adjustable characteristic values.

FIGS. 12A and 12B illustrate visual graphics 1200a and 1200b that can be generated on the one or more user devices 120. The visual graphics 1200a and 1200b can correspond to an interactive diagnostic function of the maintenance system 140. As an example, the visual graphics 1200a and 1200b correspond to a user-submitted request to the maintenance system 140 and a diagnostic interaction between the maintenance system 140 and a user, respectively. For example, when a user identifies an issue with a system component 200, or a suspected issue, the user can open an application on a user device 120 and request diagnostic assistance or service from a third-party technician. The user can input system component data 432, including a description of the issue or symptoms identified, using a textbox 1210, or by selecting or highlighting one or more of options on a pre-generated list of issues 1220. The inputs are not limited to those shown in the visual graphic 1200a but can include other inputs including video, images, audio, codes, documents, links, and similar. The user can use navigation links 1230 to navigate to other portions of a service request or other interfaces, including but not limited to, an “expert call” feature where a user can select to chat live with an equipment specialist and/or maintenance expert to assist in diagnosing and resolving the issues.

When used throughout the disclosure, one skilled in the art will recognize that “expert” can include, but is not limited to, an individual trained in, or familiar with, a variety of system components 200 and/or connected aquatic systems 100. In some embodiments, an “expert” may include a machine learning process trained to facilitate identifying system issues and providing customized recommendations for resolving the system issues.

In some embodiments, the user may have the option to choose to chat live on-demand with an expert or to schedule an expert call at a time convenient for the user. In some embodiments, the user may use a scheduling feature to input available dates/times, wherein the maintenance system 140 can use the availability in scheduling expert calls. In some embodiments, when a user selects to call an expert on demand, live chat, or similar types of communication, the system can provide a queue of how many callers or users are in front of the specific user.

The expert can participate in a text chat, e-mail conversation, voice call, video call, or other forms of communication. The visual graphic 1200b shows an example video call with an expert, utilizing video call features such as live video feed of the expert 1240 and the user 1250, text chat features 1260, as well as video call options 1280 like stop/start using camera, mute microphone, reverse camera, upload content, and other options. The video call feature can be integrated with the maintenance system 140 and the diagnostic module 410 in order to facilitate identifying the issue with one or more system components 200. In some embodiments, a user's record information 1270, including but not limited to, previous service calls, address, an equipment list associated with a user record, a preferred expert and/or third-party “dealer” can be saved and accessed by an “expert” and/or third-party “dealer with authorized access to the user's record information.

In some embodiments, the expert can receive and/or retrieve data sets and other information from the maintenance system 140, the one or more system components 200, the central controller 110, and/or the user device 120. In some embodiments the expert can receive and/or retrieve the data sets and communicate with the user via the user device 120 by utilizing an expert device or system (not shown). In some embodiments, the expert device or system can be any device capable of connecting to the Internet, similar to the user device 120. In one embodiment, the expert device or system can be a portable device like a smartphone, tablet, laptop, other computing device, or other display interface.

In some embodiments, the maintenance system 140 can facilitate data transmission between the user device 120 and the expert device or system. In some embodiments, the maintenance system 140 can also record the information used and/or accessed by the expert during a service call and can send the expert one or more data sets related to the specific user's record, including but not limited to system component data 432 and user data 434. In some embodiments, an expert can generate a report or summary of a call for the user to access and view.

FIGS. 13A-13C illustrate visual graphics 1300a, 1300b, and 1300c that can be generated on the one or more user devices 120. The visual graphics 1300a, 1300b, and 1300c can correspond to one or more interactive functions of the maintenance system 140, including but not limited to: the diagnostic module 410, the deployment module 412, and the notification module 414.

FIG. 13A illustrates a visual graphic for a customized output 1300a of the diagnostic module 410 when third-party service is recommended. If an output of the diagnostic module 410 is a recommendation for third-party service or repair, the deployment module 412 can provide a customized recommendation interface 1310 for providing a list 1330 of curated third-party service providers or “dealers” according to the deployment sequence 700, in one example. The customized recommendation interface 1310 can be used to assist a user in selecting one or more dealers to request a service estimate from. Once the user selects one or more third-party dealers, the deployment module 412 and deployment sequence 700 can generate and transmit notifications to one or more third-party systems 160 associated with each of the dealers. If the user data 434 includes a preferred dealer selected by a particular user, the preferred dealer information 1320 can be provided on the customized recommendation interface 1310. In some embodiments, the user may input information to request a third-party join or otherwise access the interface. The user may have other options available through one or more customized recommendation interfaces, including receiving, reviewing, accepting, or rejecting estimates from the one or more dealers. Once a service request is accepted and confirmed by one or both of the user and the third-party servicer, either (or both) of the user and the third-party may upload additional instructions or provide reminders. The maintenance system 140 can also facilitate coordination of the service schedule and/or providing reminders related to the service call, in addition to other features and services. In some embodiments, the user may use a scheduling feature to input available dates/times, wherein the maintenance system 140 can use the availability in deploying third-party service providers or technicians.

FIG. 13B illustrates a visual graphic for a customized maintenance interface 1300b. The maintenance interface 1300b can include water chemistry tracking 1340 and the ability to view trends and reports over time. In some embodiments, the water chemistry tracking 1340 may include notes regarding standard values and/or recommendations to adjust the recorded water chemistry to be within the standard or acceptable level.

The maintenance system 140 can communicate maintenance reminders 1350 according to system component data 432 including manufacturer recommendations and usage reports. In some embodiments, the maintenance reminders 1350 may be generated based on industry standards. In some embodiments the generated maintenance reminders 1350 can be toggled on/off, modified, deleted, or otherwise be customized by the user and/or an expert. In some embodiments the maintenance reminders 1350 can be categorized based on frequency (e.g., daily, weekly, monthly, annually, etc.). In some embodiments, the maintenance reminders 1350, and other aspects of the interface graphics shown in FIGS. 11-15, may include integration with one or more third party systems 160 or one or more third party applications (not shown) like, for example, a calendar or payment feature.

In some embodiments, the maintenance reminders 1350 may be customized according to one or more features of a user's connected system 100. For example, the user may include in a user profile, information related to the type of pool filter used (e.g., cartridge, sand, or diatomaceous earth, etc.), whether or not a user has a spa or hot tub in their connected system 100, a pool material (e.g., fiberglass, vinyl, concrete, etc.), pool size (e.g., volume, capacity, dimensions), pool type (e.g., in-ground, above-ground, infinity, lap pool, swim spa, hot tub or spa, etc.), sanitization method (e.g., chlorine, saltwater, ozone, UV, etc.), and/or season type (e.g., year round, summer, etc.). This user-specific information can be used to further customize maintenance reminders 1350 and can also be stored and used by the maintenance system 140 for other analysis and processes as described herein. In some embodiments, the user may upload photos of the connected system 100 and this information can be transmitted to the maintenance system 140 and used in the processes described herein.

In some embodiments, the maintenance interface 1300b may include a consolidated notification interface with one or more filter or organization tools. The consolidated notification interface may include one or more of a summary of: payments, estimates, maintenance reminders, parts status, service call reminders, etc. A user can also add tasks to a to-do list or further customize maintenance reminders and tasks.

The maintenance interface 1300b can also be used to schedule diagnostics with an expert, routine maintenance with third-party service providers, service requests with third-party service providers, view summary reports of previous diagnostics and service requests, view historical data based on geographic location and/or system component type, and other features and functions. In some embodiments, the particular features and functions of a user interface can be customized based on a tier or access level of a user. In one example, the access level of a user can be determined based on agreement and/or payment for specific features.

FIG. 13C illustrates a visual graphic for a customized self-education library 1360. The maintenance system 140 can be used to generate a library 1360 of tutorials and instructions for user self-repair or self-maintenance. The library 1360 can be customized to populate videos according to a user's specific system components 200, as determined by the system component data 432 and the user data 434. The library 1360 can be further customized according to usage for a particular user, a particular system component, and/or a geographic location the equipment is installed. In some embodiments, the system can automatically provide a customized list including but not limited to videos, tutorials, instructions (e.g., setup, configuration, and/or maintenance), and other information from the library 1360. In some embodiments, the customized list and/or customized self-education library 1360 can be generated using machine learning techniques or similar, including but not limited to, processes described in connection with FIG. 11. In some embodiments, a customized output including lifestyle content and guidance can be provided by the processes and systems described herein (e.g., pool party preparation, best practices for off-season pool care, etc.). In some embodiments, a video of the customized self-education library 1360 can be integrated with the maintenance interface 1300b, such that maintenance reminders include written and/or video and/or audio instructions or other tutorials to assist the user in self-repair or self-maintenance activities.

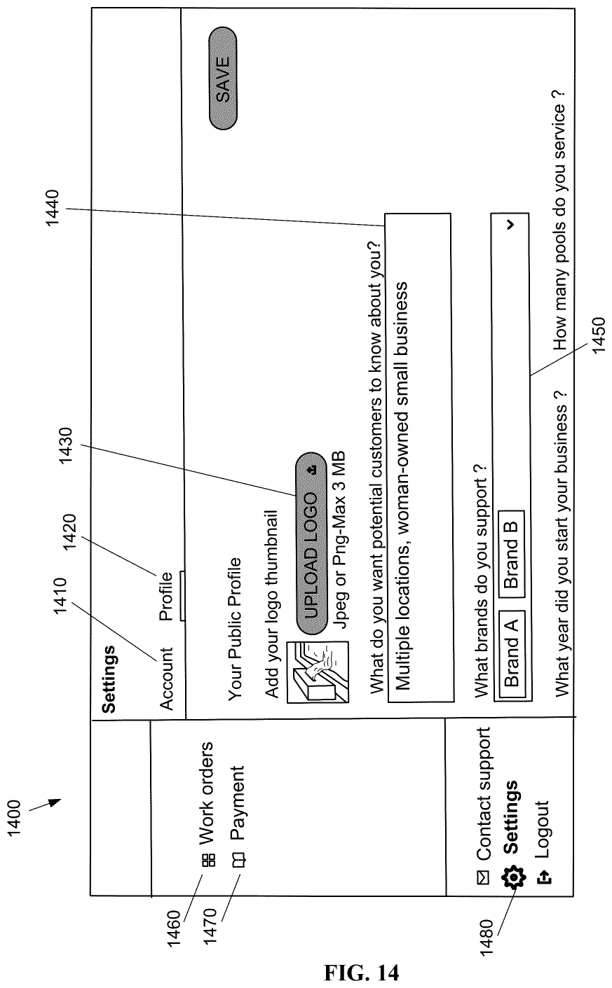

FIG. 14 illustrates a visual graphic of a third-party servicer profile interface 1400. The third-party servicer profile interface 1400 can be used by a third-party (e.g., dealer) to communicate attributes to the deployment module 412 of the maintenance system 140. The attributes can include, but are not limited to, the information input to a third-party system 160 settings 1480, and/or a profile 1420. The information can be stored as third-party data 436 in one or more databases 430 (see FIG. 4). The attributes can include a name and logo 1430, a customized description 1440 of the services provided and/or information about specific brands or component services 1450, and other information. Third-party data 436 may also include record information 1410 and other information as discussed in connection with FIG. 4.

A third-party servicer profile interface 1400 may also include navigation links to access work orders 1460 and other administrative functions, and payments 1470. In some embodiments, work orders 1460 may include a summary or overview of user and request status, estimate generation and transmittal, service request confirmation, technician assignment and information sharing, report generation, parts supply, parts ordering, advanced user profile data information (e.g., chemical tracking), digital integration for technicians engagement, advanced service and relationship recommendations, parts supply, reports, and other digital connected aquatic system solutions. In some embodiments, payments 1470 may further include estimate generation and transmittal, invoicing to users and payment collection from users, promotional codes, and other metrics or functions. In some embodiments, an expert, as discussed in connection with FIG. 12B can connect or otherwise communicate with a third-party servicer profile interface 1400 to generate service requests and input diagnostic information from the expert call and/or the diagnostic module 410, or other system outputs as described herein. In some embodiments, the particular features and functions of a third-party interface and/or hierarchy in the deployment module 412 can be customized based on a tier or access level of a third-party. In one example, the access level of a third-party can be determined based on agreement, payment for specific features, number of service requests accepted and/or completed, quality, or any combination of these or other factors.

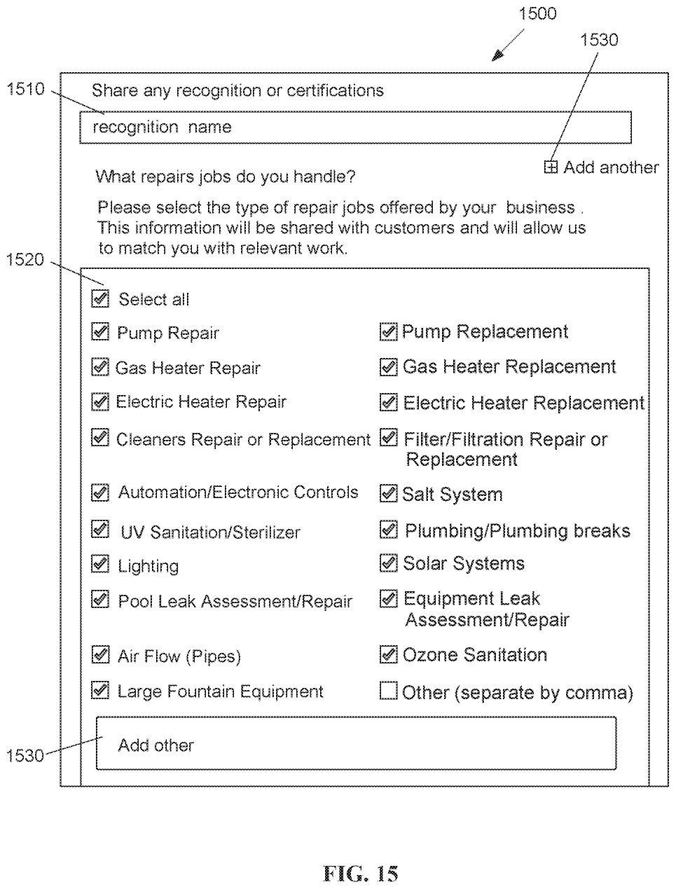

FIG. 15 illustrates a visual graphic of another aspect of a third-party service profile interface 1500 where the interface includes an attribute input function 1520. A third-party servicer can list any recognitions or certifications 1510, and any specific capabilities 1520 or service offerings available. The third-party service profile interface 1500 can be further customized to provide additional inputs 1530 to indicate a third-party's attributes. The attributes are used in the deployment process 700 can be used to match one or more service requests with one or more third-party service providers capable of fulfilling the service request based on one or more factors, including but not limited to attributes and location, brands or manufacturers that are serviced, and/or other factors listed in connection with FIG. 7 and other factors.

In some embodiments, the third-party system 160 can include a technician deployment process and/or system. In this example, a third-party can assign a technician to complete a service request. The technician can include the service request information, system component data 432, and user data 434, and any other information relevant to the assigned service request. In some embodiments, the technician can use a device, like a user device or similar, to transmit notifications, reminders, updates, reports, photos, notes, etc. The information from the technician can be transmitted to the maintenance system 140, the user device 120, and/or the third-party system 160. In some embodiments, the technician can access the maintenance system 140 and/or contact an “expert” to identify issues, obtain service information, and/or other information useful to complete the service request.

It should be noted that while the systems and methods disclosed and described above with respect to FIGS. 5-11 are directed to monitoring the health and status of one or more of the system components 200 shown in FIG. 2, similar systems and methods are contemplated with respect to additional system components 200 of the connected system 100, not shown in FIG. 2 as would be understood by those of ordinary skill in the art.

Additionally, the embodiments described herein are further directed an improved system and methodology for using sensor or other diagnostic data from connected aquatic systems to monitor the health and diagnose malfunctions of individual system components and changes to the reservoirs in which components are installed. These embodiments represent an advancement over the prior art for several reasons, including that the systems and methods are capable of simultaneously monitoring and predicting changes in reservoir conditions and conditions within individual structures. The embodiments can include measuring the operation and condition of components within a connected system, accumulating these measurements across a field of the connected system, performing statistical analysis on the accumulated measurements, performing advanced diagnostics, and producing one or more customized outputs.

These embodiments relate to monitoring of the connected system in order to avoid sudden halts in the operation and to provide planned maintenance, such as replacements or repairs before a critical situation occurs. This advantage can be accomplished by measuring one or more values that are used to compare to pre-determined thresholds according to manufacturer recommendations and usage data. The measurements are then transmitted to a maintenance system that is designed to process and analyze the data through advanced and integrated data analytics techniques to provide an accurate diagnosis and appropriate recommendation for corrective action. The maintenance system can further facilitate an efficient third-party service request by coordinating the repair specifications with known parameters of particular third parties. The maintenance system may also provide the user the option to attempt self-repair by providing customized recommendations for video tutorials and/or on demand repair assistance remotely. Thus, the maintenance may be performed before the connected system stops operating or preventative maintenance can be performed before system components malfunction.

In an embodiment, an integrated and advanced analytics system for processing and evaluating an operational state of the connected system in a dependable, accurate, and efficient way is provided. The health monitoring of the operational integrity of system components, in real-time, such that deterioration/degradation can be monitored and assessed with comparisons being made and allows for targeted preventative maintenance to be conducted before failure occurs. Additionally, historical and geographic data (in addition to other statistical reporting capabilities) can be used to further improve data analysis and provide customized recommendations not only tailored to a specific user and/or third-party, but also based on general information for users with similar usage patterns and/or in geographically similar locations. Moreover, unexpected failures can be mitigated, allow for preventative maintenance, and aid in the diagnosis of faults. However, should sudden failures occur, the data obtained from the condition monitoring system also allows for the efficient locating of faults so that remedial actions can be targeted, which again saves time and resources.

Even if the terms “value, parameter, location, component, device, unit, set, module, controller, server, measuring device, sensor, network” and similar, are used in the singular or in a specific numeral form in the claims and the specification the scope of the system should not be restricted to the singular or the specific numeral form. It should also be noted that one or more of the above-mentioned structure(s) may be provided.

The connected aquatic system includes devices or equipment that are designed to be used with the aquatic system and/or may be located in water during operation (e.g., at least partially or entirely submerged) and/or on a pool pad or installed adjacent to the aquatic system. The system components, devices, or equipment may be used in any environment and may be embodied as an electrical connector and/or penetrator or advantageously as a wet connector/penetrator, or as a connector part. Moreover, the system components, devices, or equipment are advantageously employed in a high voltage application, and also may be used in a medium or low voltage application.

Furthermore, the operational parameters can include a physical parameter, like pressure, temperature, current, voltage, etc. and the operational parameter can include a differential measurement or number obtained for one parameter. The one or more operational parameters as used herein refers all to the similar values gathered or provided at different points in time. Moreover, a selected location should be understood as a location where condition monitoring is especially of interest or relevant.

Further still, a derivative as used herein means a result of an operation performed on the one or more operational parameters. The operation may be any operation feasible for a person skilled in the art, like a mathematical operation. The derivative may be, for example, a specific difference between at least two values or a special gradient of several values, or a selected pattern of several values. In embodiments, the term “predefined” should be understood as “selected beforehand” and/or as “being saved in a control unit to be recalled for the comparison”. A reference as used herein may be any reference value or values feasible for a person skilled in the art. The reference may be a single value or several values or a correlation of several values.

According to an embodiment, the reference defines an abnormal behavior of the device and/or a part thereof as being outside of a predefined acceptable operational range. As a result, unstable and critical conditions of the device can be identified, and suitable measures can be initiated to stop or undo problem(s). Abnormal behavior as used herein means a condition where an action should be initiated to act on the system component or its current operational state and/or when the operation of the system component deviates from an acceptable, secure, or ideal operation.

In a further embodiment, the system activates at least one compensating action by the sensor system in case of detection of abnormal behavior of the connected aquatic system and/or a part thereof. Hence, a suitable measurement can be taken to prevent an un-advantageous and/or a detrimental operation and thus possible damage of the system component or parts thereof. In this context, a “compensating action” as used herein is an action that alters operation of the system component or the system to correct the abnormal behavior and/or to limit or prevent damage to the underwater device or the system from the abnormal behavior. The compensating action may be any action feasible for a person skilled in the art, like a de-energizing of the system component, an initiation of a tighter maintenance regime, activation of a maintenance action, especially a preventative maintenance action, or a reduction of a current for the system component. The compensating action can be actuated or triggered by any mechanism or actor suitable for a person skilled in the art, like from a control system and/or a person monitoring a control system.

The operational parameter may be any parameter feasible for a person skilled in the art. Advantageously, the operational parameter is a parameter selected out of the group of one or more of a temperature, pressure, humidity, a position, an electrical value (like the current, voltage, or resistance), or quality of fluid. Thus, a wide variety of different situations and operational scenarios can be monitored.

The temperature may be sensed using a temperature sensor, or a thermocouple sensor, a thermistor sensor, a resistance temperature detector, a thermometer, an IR temperature sensor, a semiconductor-based sensor, or another commercially available temperature measuring device. The pressure may be sensed using a pressure sensor or using a potentiometric, a capacitive, a piezoelectric, a strain gauge based, or another commercially available pressure measuring device. The measurement may, for example, be achieved by measuring one or more electrical properties (such as conductance, capacitance, inductance, etc.) using flow, current sensor, vibration etc. The measured value, which could be permittivity, is compared with a database value stored at the cloud server or in the control unit, and a relative measurement is obtained.

Temperature increases may lead to aging and degradation of insulating and sealing components, particularly polymers, resulting in reduced performance and potentially premature failure. Severe pressure differentials may lead to rupture of compensating diaphragms or failure of sealing elements resulting in water ingress.

In an embodiment, the same parameter is monitored at different locations of the system component, or in one or more or the one or more system components. Hence, the overall integrity of the system component can be monitored more precisely. In this context, “several locations” is defined as more than one location. In other words, different parameters may be monitored at the same time and/or the same location. Hence, a more accurate current state of the system component can be provided. In this context, several parameters are intended to mean more than one parameter.

Additionally, certain dynamic changes allow the system to react to its environment and thus initiate sensors to work in an optimized way under such conditions. When the data is provided by the sensor system from one or more locations, it is sent to the central controller 110 or local control unit for analysis using multiple processes to deduce and calculate the current situation of the connected aquatic system. The results of the provided data and/or the at least one value derived from the data and/or at least one derivative derived from the provided data defines the current operational state of the connected aquatic system.

Furthermore, the system includes a control unit for determining the operational state of the underwater system with the help of a statistical method. The statistical method may be any method suitable for a person skilled in the art, like the use of a statistic estimator, a regression analysis, etc. The operational state of a part of several parts of the system component(s) may be determined in conjunction with a statistical method specifically designed to determine the operational state.

According to a further aspect of an embodiment, a system for monitoring the health and status of the connected aquatic system is provided. The system comprises a sensor unit designed to measure several parameters of the one or more system components. A central controller and/or local control unit is communicatively coupled to the sensor unit to process the data provided by the sensor unit. The sensor unit may be removably attached to one or more locations of the system component. Further, a local display unit or interface can be connected to the central controller and/or control unit to present the information received from the one or more sensor units. The central controller can process the information and send alerts or notifications. The connected system also uses a remote maintenance system to monitor the health and status of the system component and provide information to a user device and/or third-party systems.

Accordingly, the remote monitoring via the maintenance system of the condition of the one or more system components to provide enhanced feedback and abnormal condition detection is provided. The embodiment, through modeling of the measured parameters, provides early warning and diagnostic information, to enable preventative actions to be undertaken or maintenance to be scheduled with minimal or no effort or involvement by the user. The embodiment may be used with existing aquatic system installations, using the sensors already present, or new installations could be used.

In one non-limiting example, the one or more system components can send and/or receive data sets directly to and from the maintenance system. In some embodiments, the information sent and/or received can include monitored information regarding the condition and operating parameters of the one or more system components. In some embodiments, the one or more system components and the maintenance system can be in separate geographic locations.

In some embodiments, the one or more data sets sent to/from the maintenance system can be processed. In one example, the processed data set can be added to a modified, updated, or additional data set and stored by the maintenance system.

In a further embodiment, the processed data set can be transmitted to a third-party system, including a servicer or dealer. In some embodiments, the maintenance system can be in a separate geographic location than the third-party system(s). In some embodiments there may be several third-party systems, each of which may be in several separate geographic locations from the maintenance system and the one or more system components.

In some embodiments, the third-party system can deploy a technician or servicer and/or order components according to, in some embodiments, the diagnostic and deployment processes described herein. In some embodiments the components may be ordered from a third-party system. In some embodiments, the components can be shipped to the geographic location of the one or more system components.

There are several benefits to the embodiments such as a decrease in downtime in production due to scheduled maintenance, a reduced cost of unplanned interventions, less experienced users are able to properly maintain the system by utilizing the recommended maintenance and repair suggestions generated by the advanced diagnostic system. This also results in faster response times in reacting to maintenance or emergency situations, more efficient use of technicians by ensuring those that have the proper parts and skillset are deployed, or better visibility of system performance/status and the ability to share data with the user and other interested parties.

Therefore, the connected system 100 and the maintenance system 140 presented herein recognize the desire to provide preventive and predictive maintenance in real-time. In comparison to prior art systems, the systems 100 and 140 provide better maintenance alerts and customized service recommendations than using localized sensing components without advanced diagnostics or on demand expert assistance. The diagnostic and data set analysis system with customized deployment module can be used to improve repair and service requests for both the user and third parties. Additionally, routine maintenance recommendations according to efficient tracking, actual usage readings, and automated analytics based on manufacturer recommendations can help improve product life for system components 200 and avoid equipment malfunctions and system outages by recognizing potential issues before breakdowns occur.

Accordingly, the systems described herein enable the remote monitoring and analysis of the condition of the connected system to provide enhanced feedback, abnormal condition detection, and customized maintenance/repair recommendations. One embodiment, through modeling of the measured data sets, provides early warning and diagnostic information, to enable preventative actions to be undertaken or maintenance to be efficiently scheduled. The systems can be used with existing installations, using the sensors already present, or new installations could be provided with the components described herein.

There are several benefits to the disclosed systems, such as, for example, a decrease in downtime in production due to scheduled maintenance, a reduced cost of unplanned interventions, assisting users in self-diagnostic activities, maintenance procedures, and DIY-repairs according to manufacturer recommendations, faster response times in reacting to situations, more effective system diagnostics, improved tracking of system performance/status and the ability to share data with the user and other interested parties.

It will be appreciated by those skilled in the art that while the system has been described above in connection with particular embodiments and examples, the system is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Several features and advantages of the system are set forth in the following claims.

1. An aquatic equipment monitoring system designed to monitor a status of pool or spa equipment, the system comprising:
a first system component provided in a form of pool equipment;
a first sensing device that collects a first data set including one or more operating parameters of the first system component;
a diagnostic module including a data processing module designed to receive and process the first data set collected from the first sensing device and compare one or more values of the first data set to a predefined acceptable operational range;
a maintenance system including a programmable processor designed to execute instructions when the first system component is operating outside of the predefined acceptable operational range and generate a recommended corrective action; and
a deployment module designed to generate a service request to a third-party service provider, wherein the service request includes one or more attributes related to the recommended corrective action.

2. The aquatic equipment monitoring system of claim 1, further comprising:
a second system component provided in the form of pool equipment;
a second sensing device that collects a second data set including one or more operating parameters of the second system component; and
a database designed to store the first data set and the second data set.

3. The aquatic equipment monitoring system of claim 1, further comprising:
a central controller connected to a user device and a third-party interface via a network connection; and
wherein the deployment module is designed to generate and send one or more notifications to the user device and the third-party interface based on the recommended corrective action from the maintenance system.

4. The aquatic equipment monitoring system of claim 1, wherein the first data set includes a unique identification code related to the first system component.

5. The aquatic equipment monitoring system of claim 4, wherein the unique identification code includes one or more of: a product serial number, a manufacturer identifier, a barcode, a QR code, or a RFID tag.

6. The aquatic equipment monitoring system of claim 1, wherein the recommended corrective action includes one or more of: third-party service, a replacement system component, user self-repair, remote restart of the first system component, an adjustment to the one or more operating parameters or settings of the first system component.

7. The aquatic equipment monitoring system of claim 1, wherein the first sensing device is a sensor integrated with the first system component.

8. An aquatic equipment monitoring system designed to monitor to a status of pool or spa equipment, the system comprising:
a system component provided in a form of pool equipment;
a sensing device that collects a data set including one or more operating parameters of the system component;
a central controller designed to receive and process the data set collected from the sensing device and compare one or more values of the data set to a predefined acceptable operational range;
a diagnostic module including the central controller, wherein the diagnostic module is designed to identify if the system component is operating outside of the predefined acceptable operational range;
a maintenance system designed to generate a recommended corrective action when the system component is operating outside of the predefined acceptable operational range; and
a deployment module designed to generate a service request to a third-party service provider, wherein the service request includes one or more attributes related to the recommended corrective action.

9. The aquatic equipment monitoring system of claim 8, further comprising:
a user device in communication with the central controller via a network, wherein the user device is designed to receive a user input and send the user input in the form of a user request to the central controller.

10. The aquatic equipment monitoring system of claim 8, further comprising:
a notification module designed to generate and distribute one or more notifications to a user device via the central controller.

11. The aquatic equipment monitoring system of claim 8, wherein the one or more attributes of the service request includes a unique information code of the system component.

12. A method for monitoring a connected aquatic system, the method comprising:
receiving a data set from a sensing device, the data set relating to a system component provided in a form of pool equipment and the data set including a unique identification code and one or more operating parameters of the system component;
extracting the unique identification code of the system component;
extracting the one or more operating parameters of the system component;
initiating a diagnostic module to process the one or more operating parameters of the system component;
comparing the one or more operating parameters of the system component to a predefined acceptable operational range;
determining the one or more operating parameters are outside of the predefined acceptable operational range;
initiating a maintenance system to develop a recommended corrective action for the system component; and
initiating a deployment module to take the recommended corrective action.

13. The method for monitoring the connected aquatic system of claim 12, further comprising:
initiating a notification module to generate one or more notifications;
transmitting a first notification of the one or more notifications to a third-party interface; and
transmitting a second notification of the one or more notifications to a user device.

14. The method for monitoring the connected aquatic system of claim 12, wherein the recommended corrective action includes one or more of: requesting third-party service, ordering a replacement system component, instructing user self-repair, restarting the system component, or adjusting the one or more operating parameters or settings of the system component.

15. The method for monitoring the connected aquatic system of claim 12, further comprising:
determining when the recommended corrective action includes requesting third-party service;
generating a service request using the deployment module, wherein the service request includes one or more attributes related to the recommended corrective action;
distributing the service request using a notification module to one or more third-party service providers based on a characteristic score;
receiving a response from the one or more third-party service providers; and
scheduling a technician to complete the service request.

16. The method for monitoring the connected aquatic system of claim 15, further comprising:
extracting the unique identification code of the system component from the one or more attributes of the service request;
verifying the one or more third-party service providers has a characteristic matching the unique identification code of the system component, such that the one or more third-party service providers are capable of servicing the system component; and
distributing the service request using the notification module to the one or more third-party service providers with the characteristic matching the unique identification code of the system component.

17. The method for monitoring the connected aquatic system of claim 15, further comprising:
identifying a list of one or more preferred third-party service providers stored in a user record; and
distributing the service request using the notification module to the one or more third-party service providers on the list of preferred third-party service providers.

18. The method for monitoring the connected aquatic system of claim 15, wherein the characteristic score can include one or more of a third-party service provider's:
customer reviews, inventory, years in operation, number of locations, response time, availability of technicians, weekend or evening service hours.

19. The method for monitoring the connected aquatic system of claim 12, wherein the unique identification code includes one or more of: a product serial number, a manufacturer identifier, a barcode, a QR code, or a RFID tag.

20. The method for monitoring the connected aquatic system of claim 12, further comprising:
comparing a usage data of the system component to a maintenance schedule using the diagnostic module; and
generating a notification using a notification module, wherein the notification includes a maintenance reminder.
